(19) United States
(12) Patent Application Publication
(10) Pub. No.: US 2025/0013243 A1
(43) Pub. Date: Jan. 9, 2025

(54) Situation Assessment By Way of Object Recognition in Autonomous Mobile Robots

(71) Applicant: RoTrade Asset Management GmbH, LinzLeonding (AT)

(72) Inventors: Harold ARTES, Linz (AT); Dominik SEETHALER, Linz (AT); Reinhard VOGEL, Linz (AT); Jorge Perez MINGUEZ, Linz (AT); Michael SCHAHPAR, Linz (AT); Hubert STREICHER, Linz (AT); Ondrej HLINKA, Linz (AT); Ondrej SLUCIAK, Linz (AT); Marc EGGER, Linz (AT)

(73) Assignee: RpTrade Asset Management GmbH, Leonding (AT)

(21) Appl. No.: 18/272,514

(22) PCT Filed: Jan. 15, 2022
(86) PCT No.: PCT/EP2022/050787

§ 371 Date: Aug. 14, 2024

(30) Foreign Application Priority Data
Jan. 15, 2021 (DE) 10 2021 100 775.5

(51) Int. Cl. G05D 1/617; G05D 1/246; G05D 105/10

(52) U.S. Cl. CPC G05D 1/617; G05D 1/2462; G05D 2105/10

(57) ABSTRACT

A description is given of a method for an autonomous mobile robot (AMR). According to one exemplary embodiment, the method comprises navigating the AMR through an operational area with the aid of one or more navigation sensors: acquiring information about the surroundings of the AMR in the operational area: automatically detecting subareas within the operational area and classifying the detected subareas by way of a classifier based on the acquired information wherein an area class is determined: and storing detected subareas, including the ascertained area class, in an electronic map of the AMR.

### CROSS-REFERENCE TO RELATED APPLICATION

The present application is a 371 National Phase Application of International Patent Application No. PCT/EP2022/050787, filed Jan. 14, 2022, which claims priority to German Patent Application No. 10 2021 100 775.5, filed Jan. 15, 2021, the entirety of each of which is incorporated herein by reference.

### TECHNICAL FIELD

The present description relates to the field of autonomous mobile robots, in particular concepts and techniques for object recognition and situation assessment based thereon in autonomous mobile robots.

### BACKGROUND

In recent years, autonomous mobile robots (autonomous mobile robots, AMR), in particular service robots, have been increasingly used in the household sector, for example for cleaning or for monitoring an apartment. To this end, AMRs can have various sensors for detecting their surroundings. For example, the position of obstacles (such as walls, doors, furniture and other objects standing on the floor, etc.) can be recognized by sensors and a map of the robot's operational area can be created. The map serves as the basis for the movement and work planning of the robot, so that it can carry out its task efficiently.

Some AMRs are able to identify specific objects in their surroundings and plot their position on a map. The object can be identified, for example, by an artificial marking such as an RFID tag or by means of digital image processing (if the robot has a camera). If the robot is additionally equipped with a manipulator such as a robot arm, the robot can transport the object to a desired location using the manipulator.

The following description concerns the development of an AMR to enable improved recognition and assessment of a situation that the robot is currently facing.

### SUMMARY

A method for an autonomous mobile robot (AMR) is described below. According to an exemplary embodiment, the method comprises: navigating the AMR through an operational area with the aid of one or more navigation sensors while the AMR is performing a service task; acquiring information about the surroundings of the AMR in the operational area by means of at least one first sensor, for example the navigation sensor; automatically detecting objects and classifying the detected objects by means of a classifier based on the detected information, wherein an object class is determined; and storing detected objects, including the determined object class, in an electronic map of the AMR.

According to another embodiment, a method for controlling an AMR comprises building a map of the robot's operational area; dividing the operational area into sub-areas and entering the sub-areas on the map; and determining a measure for each sub-area and a particular service task of the robot, wherein the measure represents a probability or duration for the robot to complete the service task in the respective sub-area.

According to another embodiment, a method for controlling an AMR comprises navigating the robot through a robot operational area and performing a surface preparation task or a surface inspection task in at least a portion of the robot operational area; detecting at least part of the robot operational area by means of an optical sensor; and classifying the data supplied by the optical sensor by means of a classifier, wherein the classifier calculates a value which represents a property of the surface.

A further exemplary embodiment relates to a method which comprises the following: detecting information in an operational area of an AMR by means of at least one first sensor, for example a navigation sensor; automatically detecting areas in the detected information by means of a classifier, and examining the detected information for objects belonging to a specific class and which are considered data protection objects.

Finally, a further exemplary embodiment relates to a method comprising detecting information in an operational area by means of at least one first sensor, for example the navigation sensor; storing the operational area on a map; and defining data protection areas in the map, which determine whether the information in this area may be sent to a communication connection-connected entity, in particular a cloud server

### BRIEF DESCRIPTION OF THE FIGURES

In the following, the application will be elucidated in greater detail with reference to exemplary embodiments illustrated in the figures. The illustrations are not necessarily to scale, and the application is not limited to the illustrated aspects. Instead, value is placed on representing the principles on which the application is based.

FIG. 1 illustrates an example of an autonomous, mobile robot in its robot operational area with 2 objects shown (W1 and W2, both walls).

FIG. 2 shows an exemplary block diagram showing various units of an autonomous mobile robot and peripheral devices such as a base station of the robot.

FIG. 3 illustrates an AMR which uses external and internal sensors to detect objects in the surroundings, classifies them and assigns attributes to the classified objects.

FIG. 4 shows an example in which a cleaning AMR recognizes, based on a situation (a), that a sub-area cannot be cleaned. Due to its functions, the first sub-task is postponed and a service task 2 is generated. The same AMR then performs service task 2 and then (b) resumes service task 1 (cleaning).

FIG. 5 shows an example in which a cleaning AMR recognizes based on a situation (a) that a sub-area cannot be cleaned. Due to its functions, the first sub-task is postponed and a service task 2 is generated. Another AMR (101) AMR then performs service task 2. The AMR 100 can then resume service task 1 (cleaning).

FIG. 6 shows an example of the surroundings of an AMR and the detected objects and their attributes.

FIG. 7 shows examples in which situations are recognized and, based on the situations, service tasks are started, modified or stopped.

FIG. 8 shows an example of a table in which, in addition to the standard command and the associated standard solution, other conditions are monitored and situations can thus be identified. If these conditions occur, special solutions can be used to react. This can either be generated by experience already present in the robot or by a higher-level unit.

FIG. 9 shows a living space whose areas have been broken down into sub-areas and/or zones, wherein the sub-areas being assigned measures (in this case completion probabilities). Based on these measures, the order in which processing takes place can be determined.

FIG. 10 shows the way in which an AMR can make requests to higher entities. These can be structured hierarchically as shown. An intermediate server, cloud service, etc, for example. The determined results can also optionally be sent to all intermediate stations or other AMRs.

FIG. 11 shows an object (water stain) that cannot be fully detected due to the field of view of the AMR. It is shown that the AMR can fully detect this by taking additional measurements at other positions.

FIG. 12 schematically illustrates a floor area which has soiling. Based on this, the AMR can determine the degree of dirt and determine whether cleaning should take place or not.

FIG. 13. Shows a probability map that can be constructed over time. It can be used to determine where objects are likely to be.

FIG. 14 shows a robot which, based on the internal diagnosis and additional knowledge such as map structure or cloud services, suggests the purchase of spare parts to the user.

FIG. 15 shows the map of a living space in which data protection areas, data protection objects and various restricted areas are entered. These can be entered both automatically and manually.

FIG. 16 illustrates a robot map.

### DETAILED DESCRIPTION

As a service robot, an autonomous mobile robot (AMR) independently carries out one or more tasks in a robot operational area. Examples of the tasks mentioned are cleaning a floor surface in the operational area, monitoring and inspection of the operational area of the robot, transporting objects within the operational area such as an apartment or other activities, for example to entertain a user. Such tasks correspond to the actual determination of the service robot and are therefore referred to as service tasks. The exemplary embodiments described here mostly relate to a cleaning robot. However, the concepts and examples described here can easily be applied to all applications in which an AMR is to carry out a task in a defined operational area in which it can move and navigate independently using a map.

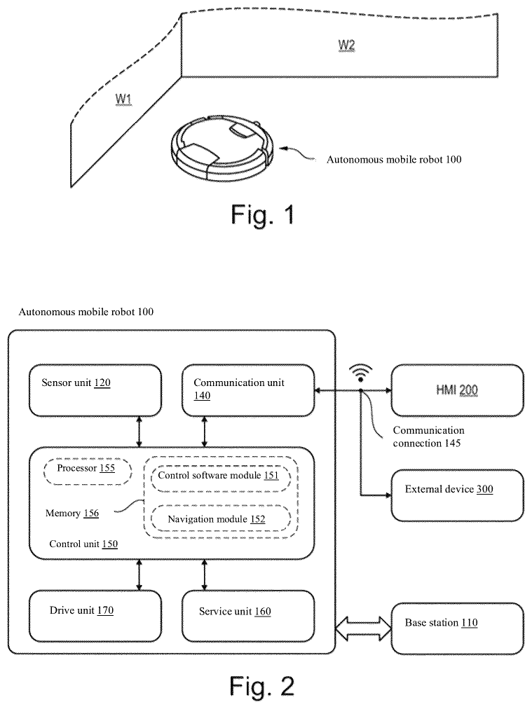

FIG. 1 illustrates a cleaning robot 100 as an example of an AMR. Other examples of AMRs comprise service robots, surveillance robots, telepresence robots, etc. Modern AMRs navigate based on maps, namely they have an electronic map of the robot's operational area. In some situations, however, the AMR has no or no updated map of the robot's operational area and has to explore and map its unfamiliar surroundings. This process is also known as “exploration”. The AMR detects obstacles as it moves through the robot's operational area. In the example shown, the AMR 100 has already detected portions of walls W1 and W2 of a room. Methods for exploring the area surrounding an AMR are known per se. A commonly used method is called SLAM (Simultaneous Localization and Mapping).

During exploration, the AMR recognizes obstacles and enters them on a map. As mentioned, obstacles can be walls, doors, furniture and other objects standing on the floor. Most AMRs only recognize obstacles based on their outer contours and store them in their electronic map of the area. The AMR usually does not distinguish whether a detected obstacle is a piece of furniture, a suitcase standing around or a pile of clothing lying on the floor. This means that an obstacle is essentially recognized as a boundary line that cannot be driven over, but an obstacle is not identified as a specific object such as a suitcase. The identification of an obstacle as an object or as an object of a specific category is possible, for example, using a camera and image processing. Alternatively, certain objects can also be provided with a marking that the AMR can easily detect such as an RFID tag.

Object recognition—namely the identification of an obstacle as a specific object or as an object of a certain category—allows the AMR to react to a recognized object in a specific way. In order to be able to make the behavior of the AMR more “intelligent”, it is desirable that the AMR is not only able to recognize certain objects, but also can evaluate the situation with which the AMR is currently confronted and adapt its behavior based on this evaluation. A “situation” is determined by the relevant objects in the working area or on the robot, or the information derived therefrom, that is available to the AMR such as maps, errors and message history. Optionally, external influencing factors such as time, surrounding conditions, weather, public holidays, information from cloud services or the service task currently being performed can also be considered as part of the situation. Before going into more detail about the various concepts of situation assessment by an AMR, the structure of an AMR should first be briefly described.

FIG. 2 shows various units or modules of an AMR 100 using a block diagram as an example. A unit or a module can be an independent assembly or part of software for controlling the robot. A unit can have multiple sub-units. The software responsible for the behavior of the robot 100 can be executed by the control unit 150 of the robot 100. In the illustrated example, the control unit 150 comprises a processor 155 configured to execute software instructions contained in a memory 156. Some functions of the control unit 150 can also be carried out, at least in part, with the aid of an external computer. This means that the computing power required by the control unit 150 can be at least partially outsourced to an external computer which can be reached, for example, via a home network or via the Internet or a cloudservice.

The AMR 100 comprises a drive unit 170, which can have, for example, electric motors, gears and wheels, as a result of which the robot 100 can—at least theoretically—reach any point in its operational area. The drive unit 170 is designed to convert commands or signals received from the control unit 150 into a movement of the robot 100.

The AMR 100 comprises a communication unit 140 to establish a communication connection 145 to a human-machine interface (HMI) 200 and/or other external devices 300. The communication connection 145 is, for example, a direct wireless connection, such as Bluetooth, a local wireless network connection, such as WLAN or ZigBee, or an Internet connection, such as a cloud service. The HMI 200 can output information relating to the AMR 100 to a user, for example in a visual, acoustic, tactile or other form, such as battery status, current service order, map information such as a cleaning map, etc., and can accept user commands for the AMR 100.

Examples of an HMI 200 are tablet PCs, smartphones, smartwatches and other wearables, home computers, smart TVs, or devices with a digital voice assistant. An HMI 200 can be integrated directly into the robot, whereby the robot 100 can be operated via buttons, gestures and/or voice input and output, for example.

Examples of external devices 300 are computers, tablet PCs, smartphones and servers on which calculations and/or data are offloaded, external sensors that provide additional information, or other household devices, such as other AMRs, with which the AMR 100 can work together and/or exchange information.

The AMR 100 may comprise at least one service unit 160 to perform a service task. The service unit 160 is, for example, a cleaning unit for cleaning a floor surface such as brush, suction device, wiping device or combinations thereof or a device for gripping and/or transporting objects such as gripping arm. In the case of a telepresence robot, the service unit 160 can be a multimedia unit consisting of, for example, a microphone, camera and screen in order to enable communication between a number of people who are physically far away. A robot for monitoring or inspecting detects unusual events such as fire, light, unauthorized persons, etc. with the help of suitable sensors, such as cameras, motion detectors, thermometers, on control trips and informs a control point about them, for example.

The AMR 100 comprises a sensor unit 120 with various sensors, for example one or more sensors for detecting information about the structure of the surroundings of the robot in its operational area, such as the position and extent of obstacles—often referred to as landmarks in the operational area. Sensors for detecting information about the surroundings are, for example, sensors for measuring distances from the AMR to objects such as walls or other obstacles, etc. such as an optical, acoustic or other sensor that can measure distances by means of triangulation, travel time measurement of an emitted signal or other methods such as triangulation sensors, 3D cameras, laser scanners, ultrasonic sensors, etc. Alternatively or additionally, a camera or chemical analysis sensors may be used to gather information about the surroundings.

The control unit 150 can be designed to provide all functions that the robot needs to move independently in its operational area and to perform a task. For this purpose, the control unit 150 comprises, for example, the processor 155 and the memory module 156 in order to run software. The control unit 150 can generate control commands, such as control signals, for the service unit 160 and the drive unit 170 based on the information received from the sensor unit 120 and the communication unit 140. On the one hand, the service unit can be equipped with drives, for example to perform mechanical work, but it can also be designed in any other form, for example as a transmission unit to operate external devices or as an interface to provide performance information. As already mentioned, the drive unit 170 can convert these control signals or control commands into a movement of the robot. The software contained in the memory 156 can also be of modular design. A navigation module 152 provides, for example, functions for automatically creating a map of the operational area and the position of the robot 100 therein, as well as for planning the movement of the robot 100. The control software module 151 provides, for example, general global control functions and can form an interface between the individual modules.

In order for the robot to be able to perform a service task autonomously, the control unit 150 can comprise functions for navigating the robot in its operational area, which are provided by the navigation module 152 mentioned above. These functions are known per se and may comprise, but are not limited to, any of the following:
determining the position of the robot on a map with no or only limited prior knowledge based on the information about the surroundings determined using the sensors of sensor unit 120 (global self-localization);
map-based path planning (trajectory planning) from a current position or starting point of the robot to a destination;
functions for interpreting the map and the surroundings such as such to recognize rooms;
the management of one or more maps for one or more operational areas of the robot assigned to the maps.

In general, an electronic map 500 that can be used by the AMR 100 is a collection of (map) data for storing location-based information about an operational area of the robot and the surroundings relevant to the robot in this operational area. A map thus represents a large number of data sets with map data, and the map data can contain any location-related information. Partial aspects of these data detects, such as a recognized contamination, a cleaning that has been carried out or recognized rooms, can also be referred to as a map, in particular a contamination map, cleaning map, and/or room map. Partial maps can also be extracted from the overall map. On the one hand, this affects locally defined areas of the map. On the other hand, partial maps are also conceivable, which depict information from the overall map that is dependent on the category.

Coordinates are used to describe the location reference of information. For example, when using a raster map for navigation, these coordinates can refer to the cells of the raster map. Alternatively or additionally, the position, extension and/or orientation of obstacles, objects, rooms, sub-areas or other structures relative to a suitably chosen coordinate system can be described by means of coordinates.

In addition, some structures can be provided with a label in order to be able to clearly identify them for a user-robot interaction. Such named structures are, for example, areas, objects or attributes. Areas represent working regions or their representation on the map. Objects are the objects located in the working region or the corresponding image on the map. This can also result in nesting. For example, objects can also contain areas or objects, or areas can contain sub-areas. Both areas and objects can have attributes. These attributes are, for example, the color or temperature of the object or area. The r coordinates, the position and/or extent of the structure and the alignment can also be understood as attributes of the areas or objects. It should be noted that attributes can also change.

In principle, areas, objects and attributes can be named by the user, by a name suggestion by third parties or devices, or automatically based on standard identifiers that are selected by object recognition. For example, the robot can use its sensors to identify an area with tables and chairs and, based thereon, determine the coordinates of a sub-area that is given the identifier dining room.

All names can be in natural language, such as room names, such as living room, dining room, etc., or object names, such as couch, table, etc.). This is favorable, for example, when the user chooses the name. Alternatively or additionally, the name can also be an abstract identifier. Various natural language identifiers can be mapped to this abstract identifier. This allows the underlying data structures to be easily applied to different national natural languages.

The exemplary embodiments described below aim to improve the AMR's understanding of the surroundings by recognizing the situation and evaluating the position in which the robot is located, thereby enabling optimized behavior, realizing new possibilities and possible uses for AMRs, and increase the efficiency and quality of the service tasks.

An AMR usually has sensors that enable it to recognize obstacles in the immediate vicinity and, for example, to prevent a collision therewith. The data detected by the sensors often lead to a direct change in behavior. Detected obstacles can also be entered on a permanent or temporary map and are then usually used for path planning or navigation. Such methods are known per se and will not be discussed in more detail here. There is usually no extended analysis of the sensor data when an obstacle is entered on the map.

An extended analysis of the sensor data could also allow conclusions to be drawn about the functions and properties of the detected objects or obstacles. By including this information, it is possible to improve the behavior of the AMR in a contextual way adapted to the situation. In order to be able to draw conclusions about the function and properties of objects, it is necessary to determine the position of objects and to identify the localized objects, for example by assigning them to a specific object category or class of objects.

It is known to use image processing techniques to locate objects in images. The calculation of object poses in images and subsequently of object poses in the surroundings is possible with a corresponding computational effort. The same applies to the categorization/classification of objects, namely when assigning the objects extracted from an image to a specific category/class of objects. However, depending on the method used, both require a high level of computing effort.

In general, there are various methods available for classifying data, only a few of which are listed here as examples. For example, there are predefined algorithms that assign data, such as objects extracted from images, to specific categories based on fixed characteristics. But there are also algorithms that can be adapted through configuration and are therefore somewhat more flexible. There are also self-learning algorithms, which are summarized under the term “artificial intelligence” (AI). These algorithms are mostly implemented as neural networks.

In the case of self-learning algorithms, there is currently still the problem that random, non-relevant correlations are also recognized and therefore a reasonable use of a solely self-learning algorithm is not readily possible. A self-learning algorithm is therefore frequently used, which is configured with the aid of expert knowledge in such a way that the desired task is fulfilled with a sufficiently reliable probability.

The measurement data from numerous sensors can be used to classify/categorize objects. Object recognition is currently often carried out by analyzing digital images. However, objects can also be recognized on the basis of other characteristics. For example, spectral analyzes or sensors that detect molecules through direct contact can provide meaningful data on objects. It is also possible to analyze and classify objects based on their geometric dimensions, such as based on the floor plan or outline. Data about the size can be determined, for example, by images, but also by scanning or tactile measurements. A classification based on typical movements or noises is also possible and often leads to reliable statements. For a further increase in the quality of the classification/categorization of objects, data from a number of sensors could also be combined, or sensor data could be used in a temporal or spatial sequence. In addition, a classification accuracy can also be calculated and optionally saved. This indicates the probability of a specific object being involved. If the results of object detection are not consistent, it is also possible to classify the object as a multi-object. Such an object either cannot be determined with sufficient accuracy using the previous analysis and could fall into several classes or corresponds to a class that cannot be assigned.

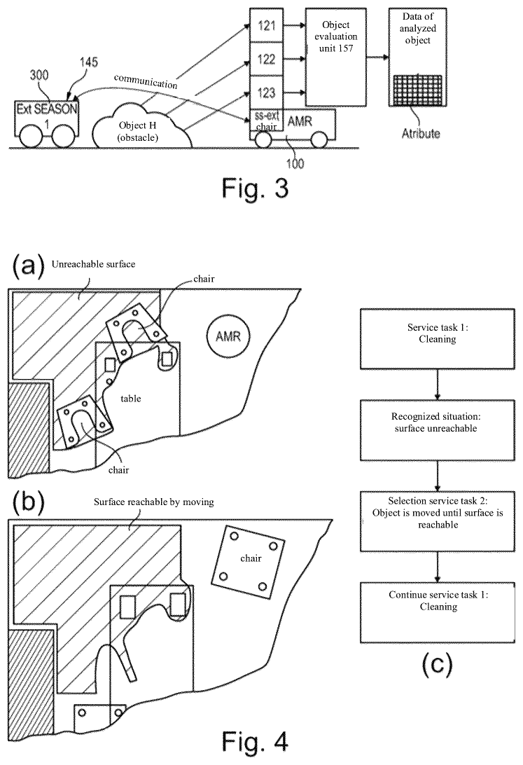

Classification of Objects and Assessment of Situations—In the example shown in FIGS. 2 and 3, an AMR 100 has a plurality of sensors 121, 122, 123. etc. A further sensor is arranged in an external device 300, such as another AMR, which is configured to communicate with the AMR 100 via a wireless communication connection 145 (cf. FIG. 2). The external device 300 can be any device such as a drone with a camera. This means that the sensors available to the AMR can be permanently or movably mounted on the AMR, or they can be “outsourced” to another device. The external device 300 does not have to be a mobile device, but can also be arranged in a stationary manner in the robot operational area, such as a surveillance camera, for example.

The sensors 121, 122, 123, etc. of the sensor unit 120 can also use additional auxiliary or supporting elements. For example, one or more lighting units can be used to better illuminate the surroundings (or part of it). A suitable light source can also be necessary for the aforementioned spectral analysis for the detection of substances. Evaluating objects based on their shadows can also require suitable lighting. Tests have shown, for example, that small objects lying on the floor can be recognized very well by the shadow if the light source is placed close to the floor and the light is irradiated approximately parallel to the floor. In order to evaluate the resulting shadow, a parallax of transmitter and receiver is of course necessary. The sensor unit 120 thus contains all internal and external sensors which provide the AMR with data about its surroundings. In this case, the sensor unit 200 is not a physical component of the robot, but a functional unit. The sensor unit can also monitor internal states of the AMR or internal states can be interpreted as signals available to the sensor unit. For example, internal messages, warnings or error messages that occur on the AMR and are only recognizable within the system can be understood as sensor signals. External data sources such as cloud-based databases or internet services that provide information, such as weather forecasts, can also be interpreted as sensor signals of the AMR.

Referring to FIG. 3, the AMR 100 comprises an object classifier 157 that may be implemented as part of the AMR's control unit 150. This object classifier 157 can essentially be considered as software that is executed on the processor 155, for example. Alternatively, the execution of the software can be completely or partially outsourced to an external server utilizing cloud computing.

After an obstacle H has been detected, the object detected as an obstacle can be assigned to a class/category of objects (object classification). Thereafter, one or more attributes can be assigned to a classified object. For example, an object can be assigned a name, such as “chair” or “plant”, geometric data, such as floor plan, height, etc., physical parameters, such as temperature, chemical composition, state of aggregation, etc., and other attributes. The attributes can be determined from direct measurement by means of one or more sensors, by analyzing data from a number of sensors or by calculation using already existing attributes. If the classification of an object is repeated later, these attributes can be changed if they have changed. The history of the attributes can also be saved. When performing a service task, the temperature and the size of a specific object can be relevant.

If an AMR is currently executing a service task, it can evaluate the situation in which the AMR is currently located based on one or more detected and classified objects and optionally their attributes. As mentioned, the situation of the AMR is determined through the relevant objects in the operational area or on the robot, or the information derived therefrom that is available to the AMR and optionally other circumstances. A situation can be evaluated more precisely the more information the AMR has about the objects in its surroundings. When a situation is detected, a specific combination of these derived information and circumstances is searched. If a situation is recognized, it can be checked whether the AMR has already an appropriate reaction to this situation. If so, the reaction can be initiated. If not, the AMR can try to develop or request a corresponding reaction. The advantage of this situation detection is that the AMR can easily “learn” new situations by reloading them, such as by the user specifying them or by adding them via a network connection. This means that service orders can be better adapted to the operational area.

Through the mentioned object classification and the assignment of attributes to classified objects, information relevant to the behavior of the AMR regarding its surroundings can be taken into account in the situation detection. When evaluating a situation, existing map entries or a combination of map data and currently detected objects can also be taken into account. Depending on the situation assessment made by the robot, the robot can adjust its behavior.

Of course, other general conditions can also have an influence on the robot's behavior. The current situation can also be considered. For example, the time, time of day, season or current task can be used. A robot can thus derive from a pending task, such as based on a voice instruction “clean around the table” a corresponding reaction. To do this, it searches for the “table” object and cleans it with the “clean around” function. The same “clean around” function could also be invoked with related instructions such as “clean the dining table area”. This can also result in unwanted instructions. For example, if it is already very late, a situation-dependent implementation could warn that it might be too loud and suggest possible alternatives. Such as “it is already very late should I clean it tomorrow at 8 am?” Another problem arises from ambiguous commands. For example, if there are several tables, a situation-dependent control could ask. For example: “the table in the dining room or in the children's room”. Instead of asking the person giving the instructions, the situation recognition could also ask for solutions to the problem from other, for example, higher-level services.

Situations can also arise through the evaluation of changes in objects. For example, a houseplant that is not watered will usually change color over time. From the hue or from the change in hue, the watering status of the plant can be deduced. If the detected obstacle was classified as “Plant”, this object of the “Plant” object class can be assigned an attribute such as “Hue” or “Watering status”. At this point it should be noted that the set of possible attributes that can be assigned to an object is determined by the respective object class. The AMR can adapt its behavior in response to the classification of an object as a plant, for example by adding this object to a list of objects to be monitored. A situation detection is created for this object and every time this object is detected again, (such as during regular inspection trips), the watering status of the plant is monitored based on the change in color.

As mentioned, the classification of detected obstacles/objects, the determination of attributes of the object, which can depend on the object class and, if necessary, the consideration of other environmental parameters, such as time, weather, room temperature, etc., enable the assessment of the current situation with which it is confronted. Depending on this situation assessment, the AMR can change its behavior “intelligently” and adapt it to a specific situation. This means that the robot can select an appropriate behavior depending on the assessment of a situation or adapt its current parameters, which determine the behavior of the AMR, and thus react “intelligently” and specifically to the situation. As a result, service tasks can be performed better and more efficiently.

Objects to be classified can be inanimate objects as well as people, animals or plants. In particular when people, animals or plants are present, it may be desirable for the AMR to display a specific behavior which depends, for example, on the person or animal specifically identified. For example, it might be desirable to provide objects needed for certain people, or to change the volume of a service task in the case of pets, such as by slowing down the AMR and, in the case of a cleaning robot, reducing the suction power. There are numerous applications for the concepts of object classification and situation assessment described here, some of which are described below.

For example, vacuum robots could avoid puddles on the floor, since liquid dirt is not part of the robot's area of operation. In order to avoid areas, it makes sense, for example, to detect the geometric size of the object and the relative path or orientation of the object to the AMR and, based on this, to generate restricted regions in the operational area, for example. Of course, it would also be conceivable that these restricted regions would be lifted or deleted again due to changed circumstances or a new situation. In this way, strategies for adequately fulfilling the service task can be derived. The supply of devices with energy or information or other consumables is also conceivable. For example, batteries of devices that are not powered by the mains could be charged regularly, when needed or on demand. This would be conceivable, for example, via a wireless charging module. A supply of information, such as updates of devices that cannot be reached directly, would also be conceivable. For such and similar tasks, it makes sense that the objects to be maintained can provide information or issue situation-related orders. For example, an update routine in the cloud or in the device could ask whether outdated firmware is being used. If so, an update mechanism could be started under optional further situational conditions, such as physical accessibility. The firmware would then be loaded onto the AMR in a first step. The AMR then moves to a region that is suitable for data transfer to the device and, in the last step, starts the update program.

In order to provide AMRs with intelligent service functions, object recognition and an evaluation of a situation based thereon are expedient. This already applies when the service task is created, but it can also only arise during the course of a service task's execution. An example of a situation analysis when creating an order is the already mentioned problem of the possible ambiguity of commands. An example of a situation analysis during the execution of an order is the already mentioned case of monitoring indoor plants.

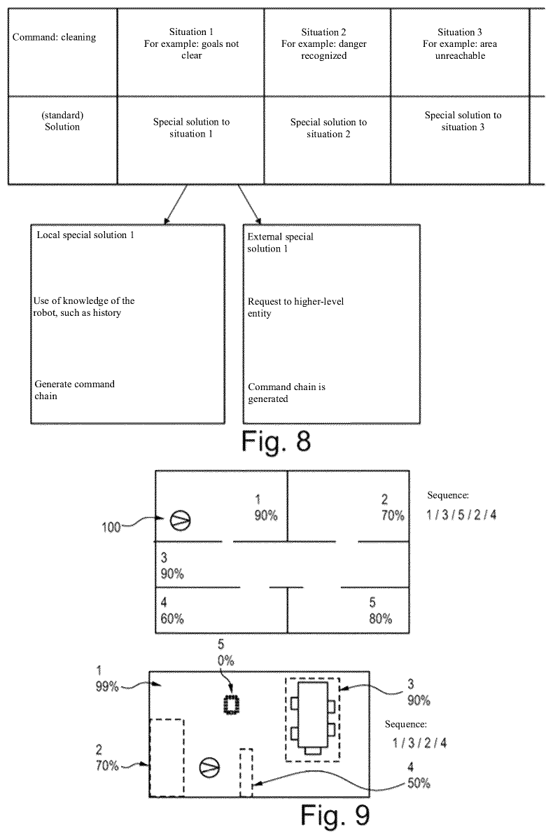

A wide variety of options are conceivable for object recognition. Thus an object could be recognized by classical image processing. However, it is also conceivable, for example, to recognize an electronic device based on its presence in the WLAN or a transmission signal. Another possibility is spectral analysis, which can be used to gain insights into the chemical structure. This makes it possible to recognize certain objects or situations and to optimize desired behavior when performing a service task through the AMR and to avoid undesirable behavior. In the course of its service task or in advance, an AMR can check the current operational area to see whether it is consistent with the service task. If this is the case, the service task can be processed in the conventional manner. If it is recognized that the situation meets certain criteria, an event is triggered that allows the AMR to react in a suitable way. As shown in FIG. 8, the decision on how to react in the respective situation could be calculated both by the AMR (local special solution) and by a higher-level decision-making instance (external special solution) requested by the AMR. The decision could then cause changes in the service task of the AMR as well as reactions from other external devices.

This is of particular advantage if the AMR can fulfill more than one service task. In this way, the AMR can be reloaded with simple functionalities for new situations. A cleaning AMR could also take over control or maintenance functions in an apartment at the same time. If the AMR then carries out a service task, it can also take care of situation detection with respect to other service tasks at the same time. If a corresponding situation is recognized, an event mentioned above is triggered and a calculation is made as to how to proceed.

A further possibility of improving the service tasks can be achieved in that the sequence in which the service tasks are carried out is based on how likely it is that the service task will be completed, what priority certain service tasks have or how quickly they can be carried out. A logical sequence of service orders can also be implemented. A task completion probability could thus be assigned to a service task or parts of the service task according to the situation. Depending on the determined task completion probability, the AMR can determine which actions or tasks will be performed next and in what form those actions, namely, actions or tasks, will be performed. For example, depending on the situation, current service tasks can be changed or interrupted in order to first carry out another task before the original service task is continued. In the first example, FIG. 9 shows an apartment in which completion probabilities have been assigned to the rooms. This could, for example, be generated from the previous cleaning processes or based on other estimates. Because of the mapping in this case, the order would be: 1(90%)/3(90%)/5(80%)/2(70%)/4(60%). In the second example, FIG. 9 shows a space in which completion probabilities have been assigned to the rooms. This could, for example, be generated from the detected objects that are in the room or also be based on other estimates. Based on the mapping in this case, the order would be: 1(99%)/3(90%)/5(80%)/2(70%)/5(50%). Region 6 would not be processed at all and would be treated like a restricted region. Such an event could of course result in further actions such as a message to the user. The examples presented could also be implemented with measures other than probability of completion. The calculated completion time or the energy expenditure could also be used or additionally used. In this case, depending on the setting for cleaning in room 1(99%), area 5(50%) could be bypassed once, such as when the detour is short, and driven through once, such as when the detour is short.

Furthermore, depending on the situation, a currently performed task can be aborted and a new task can be started. In all of these examples, the robot can react to a specific situation in which it is currently present and which it has evaluated according to specific, definable criteria.

The following are possible reactions of the AMR to a specific, recognized situation:
selecting and starting a service task,
continuing the service task
changing the parameters of the service task (speed, power, volume . . . ),
pausing or postponing a service task for a specific or indefinite period of time,
notifying or requesting solutions to a user or other entities (other AMRs or other external devices),
interrupting service tasks, and
storing or deleting data in an electronic map of the AMS or in other databases.

It goes without saying that the above list is not complete, but only exemplary. Depending on the application, various options of the AMR can be evaluated based on the classified objects or the detected situation and one or more suitable actions can be selected and executed based on this evaluation.

It is also possible that the AMR, based on a situation assessment, comes to the conclusion that a necessary action cannot be carried out by the AMR itself, such as opening a closed door or moving an obstacle. In this case, the AMR can inform the user so that he can take the necessary action. Cooperation with other AMRs or other external devices is also possible. In this case, an AMR could then commission other AMRs or external devices, or itself be assigned an order by another AMR. Of course, such generation of orders does not necessarily have to be carried out by AMR itself, but can also be carried out, for example, by a higher-level unit, such as the one shown in FIG. 10. An AMR would then make a request (A1) if the situation could not be solved by itself. The higher-level unit, such as cloud server, then checks the options available to solve the problem of the situation. Optionally, one or more computers (servers) can also be interposed. This could, for example, be hotel computer that are responsible for several AMRs. It could be the case that if the cloud finds only insufficient solutions, a human will be assigned to assess request A1. After deciding on the best method, orders (L1) are generated and commissioned for available AMRs. Depending on the implementation, it is also possible that the solution L1 is made available to other AMRs. In the case of FIG. 3, based on a similar request (A2) from another AMR (100(2)), for example, an L2 is calculated from L1 and then made available directly by the cloud.

As shown in FIGS. 4(a) and 4(b), A sequence of actions or several parallel actions could also be triggered due to a specific situation. For example, it is possible that a cleaning robot encounters an obstacle and is therefore unable to completely clean a certain region (FIG. 4(a). In such a situation, the AMR could react, for example, by instructing one or more transport robots to move the obstacle (transport robot not shown). After moving the chairs, there is a changed space (FIG. 4(b)). After reporting that this transport task has been completed or at a specified time, the cleaning robot (AMR) could continue and complete the service order “Clean room A”. FIG. 4.

Learning by the AMR—In order to give the AMR the opportunity to adapt to its operational area, functions can also be made available that make it possible to adapt the behavior of the AMR for future service functions. For example, the AMR could be conditioned in such a way that the user or the unit that commissioned the AMR gives feedback on the quality of the service performed. The feedback could, for example, be given after assessment by the user, or on the basis of before and after comparisons made by the AMR itself. The appraisal could of course also be carried out by a separate inspection unit. For example, the user could be provided with an evaluation option with which he can report back his satisfaction with the completion of a service order, as good or bad (or on a scale from 5 to 1, for example). The evaluation of individual actions or areas in which a task was performed could also be queried in this way and used to condition the behavior of the AMR. The AMR then has the opportunity to react differently in the same or similar situations. Over time, the AMR could therefore adapt very well to the operational area.

For decision-making in such situations, it is important that objects are recognized as correctly as possible. For example, if the AMR detects an object that it cannot clearly assign to an object class, it could try to obtain a more reliable classification by measuring with other sensors or by changing the robot position during the measurement.

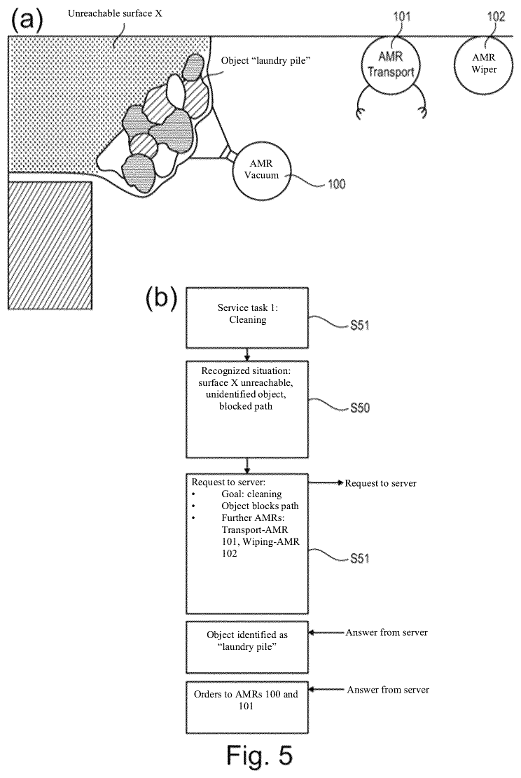

A major advantage of an AMR compared to other devices is that it can move autonomously without the user having to do anything and can also perform manipulations. The AMR can therefore change its position during a measurement or between two measurements. This also makes it possible, for example, to carry out manipulations for the purpose of object identification. As shown in FIG. 5(a), it could happen that clothes lying around (see FIG. 5, AMR 100 detects object “laundry pile”) are identified as clothes, but the type of clothing, such as socks, trousers, etc., cannot be assigned due to the location. If the algorithm used for object classification comes to the conclusion that, for example, a manipulation such as unfolding of the clothing makes identification more likely, the AMR could try to unfold the clothing or change its position or lighting, and then repeat detection and classification. Of course, this behavior can be extended to other decision branches. For example, the unfolding of the clothing could only be triggered if the manipulation is classified as secure or if a significant increase in the classification quality can be expected as a result of the manipulation. Of course, the points mentioned depend heavily on the construction of the AMR. For example, an AMR 101 with gripping arms, (see FIG. 5, AMR 101) may be better suited for unfolding clothing than an AMR that can perform manipulations solely by pushing.

As mentioned, the AMR can outsource the calculations or parts thereof to a higher-level control system such as a server, such as a cloud computing service, when classifying objects and/or evaluating a situation. The quality of the classification can often be improved in this way. For example, the AMR can request the server to check an object classification that has already been carried out. The higher-level unit can then confirm or correct the previous classification. Similar requests can also be directed to the user. It can also depend on the result of the first object classification carried out by the AMR, for example on the classification quality achieved, whether a request for verification is sent to the server. It is also conceivable that requests to the server or the user relate to the assessment of a situation, or that further steps for service orders are requested. For example, the object classification by the server could result in a request being sent to the user, wherein an image of the determined situation is sent to the user. He can then decide how to proceed

Above all, complex tasks could be managed well by a higher-level unit. An example is outlined in FIG. 5 (b). If, for example, an AMR 100 performs a service task (see FIG. 5, step S50) and it cannot continue, for example due to a specific situation, namely, the evaluation of a recognized situation shows that the service task cannot be continued-(see FIG. 5, area X cannot be reached because of a pile of laundry, (step S51)), the AMR 100 could, for example, request a solution from the higher-level unit, such as a server, such as changing the situation (see FIG. 5, step S52). If there are other AMRs in the operational area, (see FIG. 5, such as transport AMR 101 and/or wiping AMR 102), he could add this information to his request. The higher-level unit could then generate a sequence of service orders to the AMRs 100, 101, 102 in the operational area, which aim to change the problematic situation. This sequence of service orders could then be performed by one or more AMRs 100, 101, 102 in the operational area. The AMRs that are available in the operational area could either be transmitted by the requesting AMR or be known to the higher-level system in some other way. A decision as to whether and how a service order or task should be carried out can be made, for example, depending on the configuration by the higher-level unit, by a local controller in the operational area, on site, after feedback from the user, or depending on the recognized situation.

Request to higher-level entity—Another use case results from the possibility of adapting or expanding the above-mentioned situation assessment by classifying recognized objects. In some exemplary embodiments, the AMR can “learn” additional object classes in the course of an update of the classifier. For example, a cleaning robot could then receive changed/extended class definitions based on data from previously detected objects, such as clothes or toys lying around.

Since a request to a higher-level control system, such as server, is usually associated with greater effort, it can make sense, depending on the application, to make decisions that affect the behavior of the AMR locally (namely the robot makes its own decisions) and only forward requests to the higher-level control system if necessary. Whether requests are carried out could be decided, for example, by a cost-benefit analysis. If the effort is too high, work is done locally. If the effort is justifiable, an request will be made. The effort could be monetary, temporal, energetic or a combination of these aspects. The probability of success could also be calculated and taken into account.

The higher-level control system can also have a user interface in order to be able to communicate with a user and to give the user the opportunity to make decisions based on the data determined by the robot and output via the user interface, perform classifications/categorizations or to take on other tasks (such as to remove the pile of laundry mentioned). An evaluation of the decisions and classifications made by the user can also be used to train a learning algorithm. In the course of time, such an algorithm could take over the evaluation/assessment of the data determined, and requests to the user become superfluous.

The adaptability of a robot could go so far that once it has been set up and switched on, it does not require any special adjustments by the user. For example, he could start immediately with a reconnaissance or cleaning trip, since almost all users do this. He could then create a suitable work plan based on the operational area and then carry it out. For example, he could start cleaning in the mornings on weekdays. If people or pets are detected, he could reschedule service orders in areas where nobody is currently present, etc. Only if the user is dissatisfied could the user send first feedback to the AMR. The robot could then search specifically for the reasons for the dissatisfaction, for example, or adopt the most likely change. Of course, this is of particular advantage for users who do not want to deal with the AMR and its possibilities in detail.

In some exemplary embodiments, the (measurement) distribution determined by the robot can be evaluated by different entities. For example, an AMR could request a higher-level cloud server. This algorithm can determine that a request cannot be specified with sufficient accuracy. The algorithm then commissions a person with this evaluation, for example. If this person cannot make a decision either, the request could be forwarded to a specialist. Once the decision is made, the decision could be fed back to some or all of the previous decision-making instances.

Once the decision is made, the decision could be fed back to some or all of the previous decision-making instances. For example, an AMR could recognize an object but not assign it to a class with sufficient clarity, so that a request could be made. After a sufficiently precise assignment by a higher authority, this decision can optionally be used in the future for lower-level instances.

In some exemplary embodiments, requests to the higher-level control system are designed to be configurable, since not all users are interested in having their data processed by external entities (servers, cloud services, people, etc.) There is the possibility that, for example, before data is transmitted to the higher-level control system, data or parts thereof are manipulated, removed or made unrecognizable. For example, faces could be hidden before transmission. Certain areas of the robot's operational area can also be subject to restrictions. For example, the robot can be configured so that no images from the study or the bathroom are allowed to be transmitted. Encryption or abstraction is also conceivable. Thus, only authorized entities or users could use this data.

A possible variant also results from the fact that the “knowledge” (such as learned data used for object classification) of the same or similar AMRs is combined. In this way, AMRs could learn from each other. Such dissemination of knowledge can also be restricted to individual AMRs or a group of AMRs. For example, mutual learning could only be allowed within the group of AMRs deployed in the same hotel, for example.

### Map of an Area With Objects and Associated Attributes

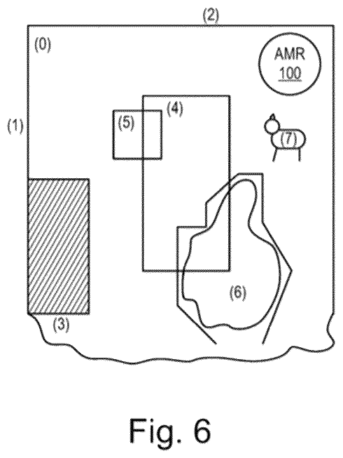

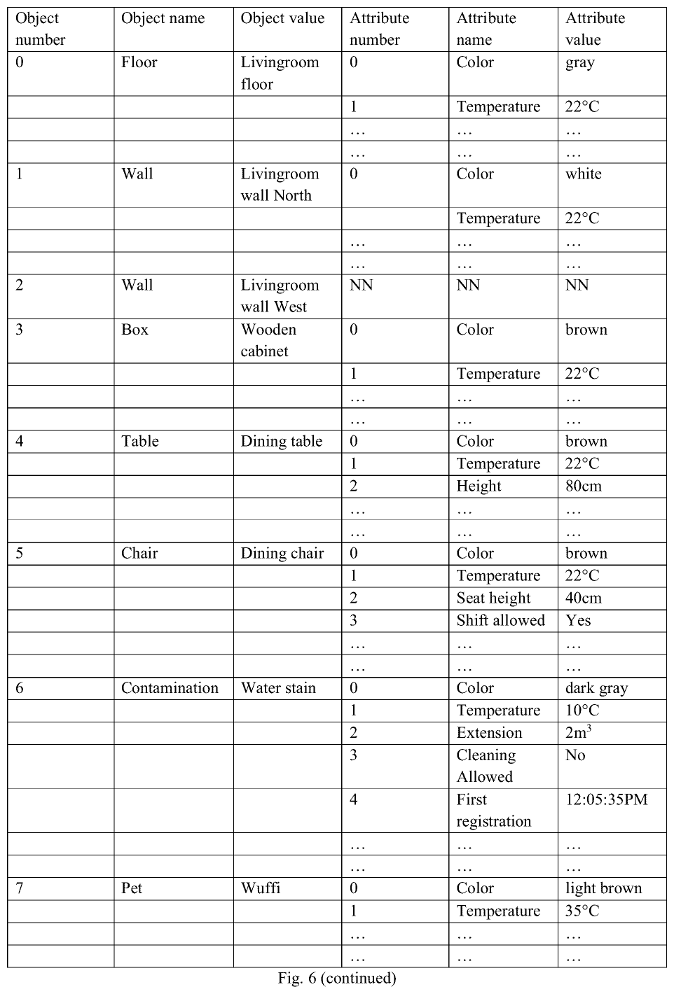

Sub-areas determined by classification situation assessment—When performing a service task, the AMR can also enter the objects identified the classifier in temporary or permanent maps. FIG. 6 shows a possible implementation. In this case, a map and an associated table in which the objects and their attributes have been entered. In this way, for example, automatic restricted areas or risk areas in relation to one or more service tasks can be saved in the map and reused later. For example, the floor area occupied by an object classified as carpet can be qualified as a sub-area of the entire robot operational area that is unsuitable for a floor mopping robot and stored as such in the map. Similarly, areas of floors occupied by objects classified as “pet excrement” can be noted as restricted areas or special zones. The same applies to floor areas covered with liquids 6. Such a special zone can, for example, be treated specifically insofar as the robot does not drive through this area, drives only at reduced speed or with the service module or cleaning module switched off. It is also possible to eliminate such special zones using other AMRs or special tools. Services could also extend to recognizing sub-area changes. For example, a spreading or flowing pool of water could be viewed as an object changing its extension.

It may also happen that when the AMR first detects the object, it is not yet able to determine the overall size of the relevant floor area. The possibility then arises of expanding or reducing the extent of the initially identified floor area by exploring the immediate vicinity, and thereby determining its overall extent. On the one hand, this can be done while the service is running, but it could also be achieved by separately exploring the surrounding area.

It is also possible that objects or floor areas that are occupied by the object receive a customized service based on object-specific properties. For example, additional service units of the robot could be switched on or off, or parameters such as speed, volume, or power could be adjusted.

Another advantage of object recognition and object classification is the possibility of checking the result of a service task. For example, after cleaning has been completed, a cleaning robot can carry out measurements, such as take pictures, and check whether the service task was carried out with sufficient quality. It would be possible to have processed areas then checked with a classifier or to add the attribute “degree of cleanliness” to the object classified as “kitchen floor”. A classification of the object before and after cleaning would probably also cause changes in the “degree of cleanliness” attribute. Depending on the application, the service task could, for example, only be evaluated as successfully completed if the attribute reaches or exceeds a specific limit value. The development of classifiers with a correspondingly high quality is relatively easy with the help of machine learning and a correspondingly large number of correctly assigned training data. A classifier is generated that is trained using known measurement data. By training with many dirty and many clean photos of floors, a classifier can be generated which, for example, can assign a value in the soiling class to a kitchen floor that has never been classified. Example: Clean vs. Dirty. Or values in between. In FIG. 12, sketch 7, 2 floors are shown, both of which are contaminated with dirt (SM). The dirt level (SG) is large in one case and small in the other case. This degree of protection could, for example, be used directly as a value for contamination. This could be implemented as a separate class or as an attribute of the floor (B) object.

A more active intervention of the AMR is also possible. For example, a cleaning robot could detect that an area cannot be cleaned because an object is blocking that area. However, if the object classification or the situation assessment indicates that the object can be moved, the AMR could do this. In some exemplary embodiments, the AMR will only move the object if this is possible without risk, or if the object can then also be pushed back to its original position.

A particular advantage for applications of an AMR is the possibility of moving or manipulating objects in the operational area. In contrast to non-mobile devices, this allows an AMR to perform numerous service tasks. The possibilities are particularly extensive when the system correctly recognizes situations and derives suitable conclusions from them.

Object recognition and classification and, if necessary, situation detection or solution search and evaluation can make it possible for the AMR to reach floor areas that were previously avoided due to the robot's lack of knowledge. For example, a robot that interprets a curtain as a wall and therefore does not touch it, could decide after object recognition to accept a collision in order to be able to clean better under the curtain.

Consequently, a similar application also arises when the doors are ajar but not closed. If it is recognized that it is a door, the AMR can try to open it carefully. This enables him to reach other rooms and carry out service tasks in a larger operational area. Among other things, care can be taken to ensure that a service task is carried out in such a way that no doors are closed and the AMR can reach all areas, in particular its base station, as well as possible. Of course, this applies in particular to base stations where the AMR itself is maintained.

Floor areas where different floor coverings adjoin one another could also be noted on the map. These floor areas pose a particular challenge when cleaning, as they often contain additional structures such as gaps or differences in height. If the AMR is able to recognize such floor areas as objects and classify them as “transitional areas between different floor coverings” and enter them on a map. Separate treatment based on this data would then be possible, such as through an additional special cleaning of the transitional area.

By recognizing special properties and limitations of objects, floor areas, such as boundary lines, which may be passed depending on the direction can be automatically entered on a map. For example, a carpet with fringes can be recognized as such and the edge of the carpet, which has fringes on two sides, can be automatically saved in the map as a “semi-traversable border”. As a result, the robot only passes through this semi-traversable boundary when it leaves the carpet. This behavior can probably prevent tangling on fringes.

Probabilities with which the service task can be carried out can also be calculated for the detected and classified objects or floor areas derived therefrom, such as those which are occupied or influenced by the object. The service task may or may not be performed in the respective area depending on the determined probability, namely, the risk of a problem in performing the service task. For example, areas in which a certain risk is exceeded cannot be worked at all, or that risky areas are only done after the non-risky work has been completed. A combination of different priorities is of course also possible.

Maps with objects—Probabilities for objects can also be recorded in the operational area map. It could happen that an object is found that has a 40% probability of being clothing, a 30% probability of being a toy and a 30% probability of being another object that cannot be further classified. These values can be used to evaluate a situation and select the AMR's behavior based thereon. It would be possible, for example, that when a distribution socket is detected in the surrounding area, there are cables to be expected. Places could also be marked in which similar objects are located. The robot can then move more slowly and/or react more sensitively to external forces, which counteract the movement of the robot, in floor areas in which there is a relatively high probability of cables lying around.

This information about the probabilities can also be used to generate a map of the robot operational area with probability of staying for object classes. Above all, global and local maxima and minima are particularly interesting.

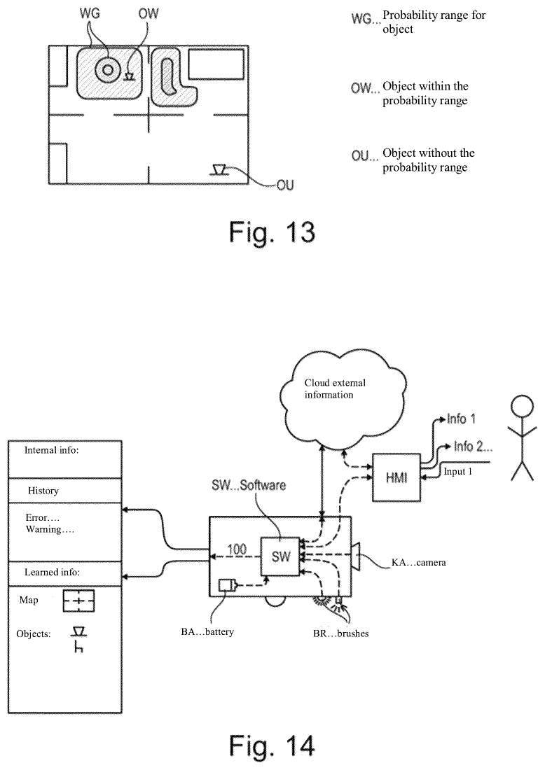

A resulting application is providing information about objects with an unusual location. FIG. 13 shows, for example, 2 objects (O) of the same class. In addition, a probability area (WG) is shown on the map. This indicates where an object of the respective class is likely to be found. For example, history could be used to create the probability class. However, the user could also define such regions. The object (OW) is in a probability area, The object (OU) is outside of a probability area. The detection of the objects (OW) or (OU) could again cause corresponding reactions. For example, a key left under the sofa could be reported as this is unlikely. Transport by transport-AMR to a suitable location is also possible The AMR could learn over time which objects are commonly found where and update the probability map. If an object is frequently in an undesirable position, this could also cause the probability map to assume undesirable shapes. In this case, countermeasures could be taken by using information from the user.

A “search and bring function” can also be implemented in this way, with the robot first searching through those regions of the operational area in which there is a high probability of finding the object it is looking for.

A user could then also commission a transport AMR to bring specific objects to specific locations. If the AMR has the appropriate capabilities for recognizing and classifying a large number of objects, it is also possible to implement more complicated processes. If the AMR also has suitable voice recognition, the following service instruction would be conceivable, for example: “AMR, please put all the empty glasses from the dining table into the dishwasher”.

For example, all clothes could be collected in one place. Items of clothing would then be objects that, in the classification, meet at least a certain limit probability for items of clothing. According to a further exemplary embodiment, recognized and classified objects are additionally sorted. It would be possible, for example, to sort the clothes by color. An analysis of the objects, for example by means of spectroscopic or chemical sensors (molecular sensors) or changed lighting, could also differentiate between dirty and clean items of clothing. A situation-dependent sorting would thus also be conceivable, for example, that depending on the state of the washing machine, so that suitable dirty laundry is already collected in the washing machine. An optional start of the next service unit is also conceivable in the following.

Of course, the previous example can also be applied to numerous other applications, such as putting away objects, such as tools or toys. Of course, food leftovers or rubbish could also be subjected to a sorting process. It is also possible to sort objects when performing another service task. For example, in addition to the actual cleaning, a cleaning robot could put away toys or sort the garbage that has been picked up. Chemical analyzes of objects could also be carried out in this way.

Object recognition would also make it possible to identify a danger area and initiate appropriate measures, such as defusing the danger or reporting the danger. Examples of this would be shards on the floor, which could be recognized by image analysis, changes in the chemical composition of the air can be detected, for example, using chemical or spectroscopic sensors.

In another embodiment, the AMR provides camera images of unusual situations. For example, photos or videos of improbable or amusing situations could be taken and made available to the user, for example via the human-machine interface.

Caring for living creatures—Another interesting option emerges in the care of plants. It would be possible for an AMR to recognize plants and check them for underwatering and overwatering with comparatively little effort. Reminders or work orders could then be sent to users or other service entities.

Similar tests are also conceivable for animals or humans. In this way, the presence of animal feed and water could be checked relatively easily. Qualitative or quantitative investigations of consumer goods are also conceivable. If necessary, goods can be reordered.

Extensive analysis of the attributes of people or animals could also allow predictions about their state of health. Changes in attributes can be an indication of undesired developments. For example, through gait analysis or noise analysis, such as coughing or the like could be diagnosed and suitable measures taken or suggested.

Another advantage of object classification and situation assessment is that AMR behavior can be triggered based on the presence or absence of an object or person. If, for example, a specific person is identified as coming to the operational area, it is possible to have work carried out specifically for this person. Users can also be reminded of a task list, such as sports or medication when they are present. Performing work or adapting service orders is also possible for animals.

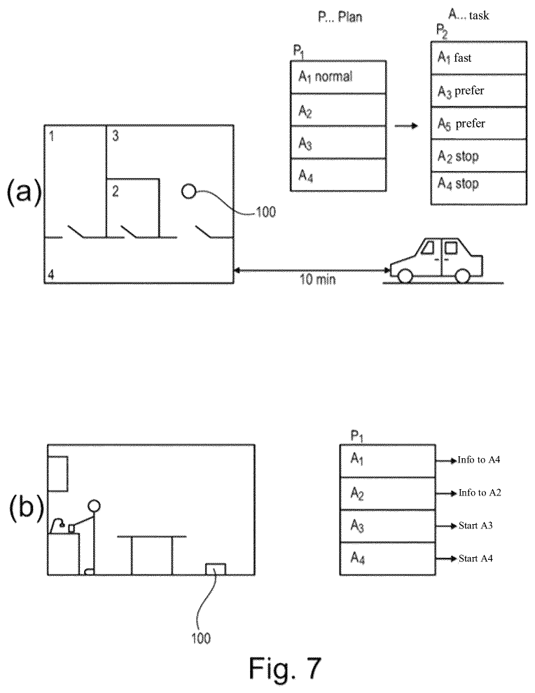

The result of a situation assessment can also indicate a specific future event. In FIG. 7(a), the AMR recognizes, for example based on GPS data, that the user will probably arrive at home in 10 minutes. A plan currently being processed (P1) is then changed to (P2). The orders are relocated, sometimes carried out faster, stopped or postponed.

As shown in FIG. 7(b), drinking a coffee in the morning, for example, could also indicate that the user is about to leave. Here, the AMR recognizes probable future behavior through the behavior of the user. Such triggers could complete plans (P1) with helpful work (A). For example, water could be requested for wet cleaning (A1), weather data could be transmitted to the user, suitable clothing suggested or made available (A2). Service orders for other service units are also possible. For example, the car could be preheated (A3), or service orders could be changed (A4) due to the weather or times of high allergen exposure. For example, wet cleaning could then also be carried out in addition to dry cleaning. Another application would be, for example, wet cleaning in the entrance area after a user has returned home in rainy weather. Optionally, this could of course also only be carried out after a query to a higher entity. Similar scenarios are conceivable for public holidays, vacation days, etc., provided the system has access to the relevant information. The same applies to attributes of objects. Windows that are open, toys that are built, etc. could trigger corresponding changes in behavior.

An AMR for surveillance (night watchman AMR) can also benefit from object classification and situation detection. If, for example, nobody is usually at home at certain times and a person who cannot be assigned enters the operational area, this can indicate a burglary. In this case, corresponding service tasks could be listed, such as take a picture, send an emergency call, trigger acoustic or light signals. Of course, this can still be improved by object and/or situation recognition. For example, an alarm could only be triggered if the person is not recognized as a valid user. AMRs can also be used for this, the main task of which is transport or cleaning, for example. Times when the robot has no other service task to perform could be used for this. For example, it could monitor the front door or other points of interest during relevant periods of the night. A large number of possibilities are again provided for sensors. These range from simple switches to complex sensors based on the evaluation of several sensors or on the temporal evaluation of the signals.

Evaluations of the mood of users can also be used for the behavior of the AMR. So it would be conceivable that at certain times or because of certain situations, they prefer a particular type of music, lighting or room fragrance. Orders could also be sent to service units for this. The setting of the desired parameters is of course not limited to evaluating the mood. For example, there could be a basic user setting that configures the appropriate default settings. Permissible adaptations could be made based on this.

Analysis of the operational area: An object or situation recognition also has the advantage that sub-areas of the operational area can be explored in detail. This offers the possibility of classifying certain sub-areas based on typical objects, such as chairs, table, stove, refrigerator, sofa, toys, etc., in the respective operational areas. Based on this, for example, a sub-area can be assigned by name. For example, a dining room, a kitchen, a children's room, etc. could be identified as such in this way.

Object recognition also makes it possible to improve the visualization for humans. For example, recognized standard objects such as a kitchen block could be visualized as such objects in the HMI. The visualized map could then be constructed based on the detected objects. The use of surface information such as textures or furnishings could also be displayed in an HMI or displayed in a simplified way. This offers the advantage that the user can be provided with an intuitive interface. The map generated in this way could, for example, also be visualized as a 3D model and used for future service tasks.

It would also be conceivable that, for example, objects or textures would be measured and detected and that this data would be made available to interested sectors. For example, 3D objects could be used to develop computer games or virtual museums could be created. The applications in this area are diverse and range from cultural to industrial plant control, through areas that are difficult to access or dangerous, regions where people could cause damage such as ancient cultural areas.

The analysis of rooms also offers other possibilities. Thus, classified objects in the operational area can be stored in a map, together with their pose and attributes. Information on this can then be called up if required. This would allow, for example, to create lists of existing objects. Inventory tasks could be completed in this way or lists of certain groups could be generated, for example a catalog of all available books or tools.

When performing the service tasks, one could also look out for special areas that are useful for certain tasks. For example, good locations for base stations or those areas that are suitable for later calibration of sensors could be searched for.

Another application is monitoring for potential damage. For example, water damage could be recognized by changes on the walls. Chemical signatures of environmental conditions could also be considered and would be recognizable via the attributes of the objects to be checked. It would thus be possible to check air quality, oxygen content or humidity. Temperature changes, contamination or pest infestation would also be recognizable in this way. It would also be possible to use microphones or other sensors to diagnose damage at an early stage. For example, bearing damage in a washing machine could be diagnosed in this way on the basis of the noise.

The data from the maps that are generated can also be used for future searches. For example, you could search for rooms that meet certain criteria. It would be possible to search for a place with a certain size, temperature or light conditions and other properties.

It is also possible to assign objects to a map that shows their location. This information could be used for optimization tasks. For example, based on the data, the paths could be optimized or an optimal area for storing the object could be suggested. It would be possible, for example, to save transport time or distances.

Another added value for the user is the possibility of suggesting suitable products based on data extracted from the apartment or objects available there. It would be conceivable to provide relevant information to the user or the seller. The provision of this data may comprise external products or services as well as products and services deemed useful for the system or AMR. For example, the AMR could use internal reports to diagnose that spare parts or consumables should be ordered as shown in FIG. 14. Internal information such as the history, such as error messages, or learned information such as objects in the operational area or maps could be used for this purpose. In addition, external information, such as from cloud services, could also be used. Information to the user could be made available both via cloud services and via the AMR directly via the HMI.

For example, the detection of a cot could indicate the presence of a child and appropriate changes to the home or appropriate advertising could be made available

For the user, this offers the possibility that he is not inundated with unnecessary advertising, but only receives information relevant to him on currently relevant situations. He could also point out the possibilities of other AMRs due to the special construction of the apartment or point out possible changes in his services. The information can be made available, for example, with messages to the user. It is also conceivable that information is made available to the user by a chat bot

The methods described here can be implemented via software. The software can be run on an AMR, on an HMI and/or on any other computer, such as in particular a home server or a cloud server. In particular, individual parts of the method can be divided into different software modules that are executed on different devices.

Object classification and map entry (FIG. 3): The exemplary embodiments described below relate to a method for an autonomous, mobile robot (AMR). The method comprises, in particular, navigating the AMR 100 through an operational area using one or more navigation sensors coupled to the navigation module 152. Information about the surroundings of the AMR in the operational area is detected with the aid of the navigation sensor and/or with additional sensors. Positions in the operational area can be assigned to this information in order to create an electronic map of the operational area or to supplement an existing map. The method further comprises the automatic detection of objects within the operational area and classification of the detected objects by means of a classifier based on the detected information. The classifier can contain, for example, a (trained) neural network that can carry out a classification of the detected objects, namely the classification determines an area class for each of the detected partial sub-areas. The detected sub-areas, including the determined area classes, can be saved in the map of the AMR.

If the classifier contains a neural network, this is trained in advance with training data. However, objects can also be classified according to specific, deterministic criteria. For example, an object can also be identified by meeting certain specifications in terms of size, shape, or color. It could also be determined based on the respective sub-area or based on other objects in the vicinity of the object. For example, a new object in a child's play area, or near other toys, suggests that this object is also a toy.

An electronic map of the operational area with stored and classified objects enables the user of the AMR to use the map of the operational area, such as visualized on an HMI, more easily/intuitively. Furthermore, the classification of the sub-areas enables the AMR to execute simple commands that are intuitive for the user, such as “clean around the couch” (abstractly speaking: “clean area around object of class X”).

The classification of objects using an “intelligent” classifier enables the AMR to assign an object \a descriptive name based on the previously determined object class. When visualizing the map on the HMI, the names of the sub-areas can be displayed and the user does not have to make any manual assignments.

In addition, attributes can be assigned to the objects, such as the color. This allows objects of the same class to be provided with differentiating features. For example, it would be possible to execute commands that would not be unique just based on object class. For example, the command “clean around the RED couch” could be given. Or with the command “clean around the couch” corresponding further questions could arise, such as: should the red or the blue couch be cleaned?” Attributes are of course not limited to the color, but comprise material, temperature, size and many other characteristics.

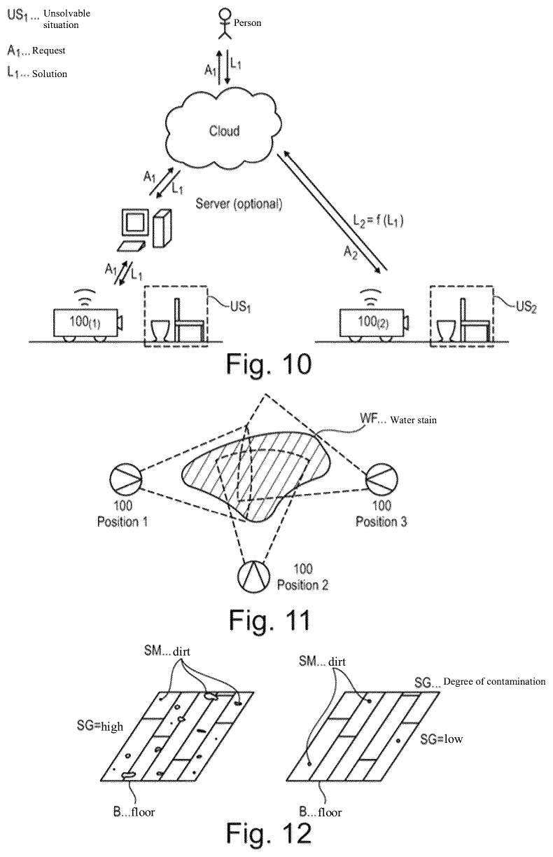

Various classifiers are known per se. Usually, classifiers contain one or more pre-trained neural networks, which not only deliver an object class as a result of the classification, but also a measure of the probability of the correctness of the classification. For example, the result of a classification can be that an object is 80% a toy and 30% a shoe. The probabilities do not have to add up to 100%. The result with the highest probability can be used as the object class. It is also possible to only assign an area class when the probability of two area classes has a certain difference. If the probability values are too low, the AMR can repeat the measurements and, for example, use additional sensors or lighting for the measurement. It is also possible to repeat the measurement if the position has changed. This can also be used when the object is so large that it cannot be detected with a measurement by the robot as shown in FIG. 11. A manipulation of objects before a new measurement is also possible. The object classifications based on objects in the immediate surroundings, or an area classification in which the object is located, could also be comprised in the object classification.

If a classification does not meet the necessary requirements to make an assignment, it is also possible that the classification can be carried out by another classifier. This could, for example, be a classifier that can be reached via a network connection and has extensive training data. It would also be conceivable for this task to be handed over to humans. Due to these expanded classification options, it is often possible to perform a correct object detection fully automatically.

If a classification is incorrect or the user wants to change it for other reasons, such as because the object is used differently or it does not correspond to a standard object, this can be adapted accordingly via a human-machine interface (HMI). In this case, the user could select from a set of possible standard area classes, or create individualized area classes that the system does not yet provide.

In the course of this individualization, objects for which the classification is less clear than desired could also be suggested to the user for checking. In this way, the system can be highly customized on the one hand and require low-maintenance on the other, due to a high level of automation.

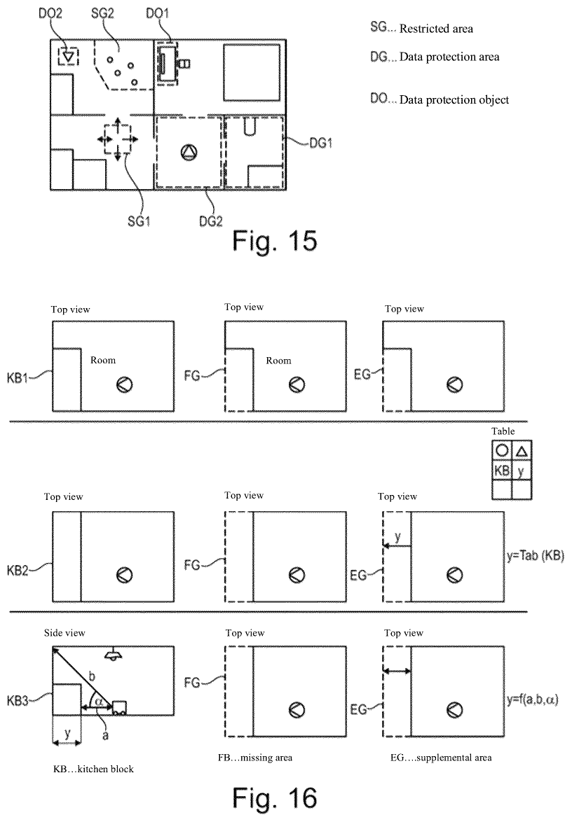

An example also comprises the possibility of providing objects or object classes with information that provides information about which actions are permitted or not with corresponding objects. This assignment could be done automatically by the robot in a first run based on the object class and later changed by the user. Possibilities for such actions are, for example, the creation of restricted areas for specific service tasks. For example, the detection of animal excrement or a vase could result in a restricted area being set up. Another example would be that data protection is set up for certain objects whereby the robot is prohibited from sending data of the object via a communication interface as shown in FIG. 15. It is also possible to provide objects with the “Edit/Check” action. For example, the detection of a houseplant could result in the irrigation status being checked and the plant watered if necessary. It would also be conceivable that a detection of larger dirt particles prompts the robot to immediately remove them in a small routine and then continue with the usual cleaning. Of course, this could also only be carried out if dirt is detected in an area that has already been processed. This method is also advantageous if you want to avoid dirt not being removed because it can move, for example. This can be caused by the side cleaning brushes of the robot itself, for example.

Allowed moving of objects can also be provided in this way. For example, it could be permissible to move packages that are on the floor or to open doors. In a further developing stage, it would even be possible for a manipulation to only be carried out if it can be undone by the robot. In this case, a package could only be moved if it could be pushed back in place afterwards. The benefit of linking objects or object classes to tasks is that the robot has significantly more options to deal with a situation. In addition, on the one hand, there is a high level of customization and, nevertheless, due to automation options, the necessary interaction with the user can be reduced to a necessary level.

Classifiers usually get better and better with growing databases. In addition, classifiers can be extended by additional classes. For this reason, it makes sense to set up the system in such a way that the classifiers can be exchanged using an update process. As a result, the robot can recognize additional object classes over time and, based on this, additional functions can also be added.

In order to be able to generate classifiers with the appropriate reliability, it is important that a sufficiently large amount of training data is available. One way to get suitable training data is, for example, to use data that the robot has sent to a higher-level classifier for evaluation. In order to enable training with this data, this data must first be assigned to one or more classes. This assignment could be done by humans, for example, or by using that area class that the user ultimately confirms or specifies. Of course, data could also be used in areas that have already been correctly assigned, provided the user makes this data available. This makes it possible to continuously improve the classification.

Another possibility is that the user or a unit connected via a communication unit is informed that an object of a specific class has been recognized. Information about the attributes of the object can also be forwarded. Typical objects that can effectively use such a function are objects that indicate damage or a future problem. For example, a water stain on the wall could indicate a broken water pipe.

In order not to provide the user with unnecessary information, it would also be possible to inform him only when an object is recognized for the first time. He could then, for example, check the corresponding assignment of the object class and, if necessary, make configurations. For example, whether this object can be moved.

In the case of an object that requires maintenance, such as a houseplant, the user could only be informed when certain attributes indicate this necessity. In this way, the user can be informed when a check is reasonable or when there is a need for action.

Robots can also be used in a relatively simple manner to maintain devices in the operational area. It would be conceivable, for example, for them to establish a connection with devices using a communication interface and make information available for these devices. Of course, this is of particular advantage above all when the devices themselves do not have direct access to the information. In this way, devices could, for example, carry out an update even though they do not have access to the WLAN due to their location. A similar problem arises with devices that have to be supplied with energy. Since most devices are not mobile, they cannot charge themselves or are connected to wires. A robot could supply such devices with energy by serving as an interface between the energy source and the device. For example, a robot could have a module that provides a QI charging function. This module could also be designed as an option, in which it is not provided in the standard variant and the charging function is only available later as an upgrade when the corresponding module is purchased. The corresponding counterpart could either be the device to be supplied itself, but it could also be a connecting device. For example, to charge a mobile phone on a piece of furniture that has no access to the power supply network, this connection device could be integrated into the piece of furniture or retrofitted with it. The connection device could be designed, for example, in such a way that it has a charging function interface in an area that can be reached by the robot, for example near the floor. This charging function interface allows the device to charge its own battery when the robot provides its charging function. The connection device also has an energy delivery area which is connected to the battery with a cable, for example. This energy delivery area then forms the actual charging function of the mobile phone. If this is again equipped with a wireless charging function, for example, a mobile phone could be conveniently charged on almost any piece of furniture.

First and foremost, of course, in addition to power supply by cable, power supply by electromagnetic radiation is a main option.

Even when it comes to power supply, this could be done with cables or wirelessly, for example with QI charging technology.

This function could also be designed in such a way that a power supply is only carried out if this is recognized as necessary.

On the one hand, an energy source specifically provided for this purpose could be provided on the robot as an energy store, which is made available, for example, in a free optional module, but the battery already provided on the robot could also be used.

The recognition of objects can also be used to make further information about objects available. For example, the 3D structure of the object could be extracted and saved.

Also the extraction of the texture of an object can be extracted and saved.

Both the 3D structure and the texture could be used in the HMI to provide the user with improved visualization.

The exemplary embodiments described below relate to a method for an autonomous, mobile robot (AMR). The method comprises, in particular, navigating the AMR 100 through a operational area using one or more navigation sensors coupled to the navigation module 152. Information about the surroundings of the AMR in the operational area is detected with the aid of the navigation sensor and/or with additional sensors. Positions in the operational area can be assigned to this information in order to create an electronic map of the operational area or to supplement an existing map. The method further comprises the automatic detection of objects within the operational area and classification of the detected objects by means of a classifier based on the detected information. On the one hand, the detection can take place by dividing the operational area into sub-areas, such as rooms, in advance, and then classifying these sub-areas. Another possibility is that the robot detects one or more objects and then creates an area in which the objects are located. Another possibility is that the robot detects information about its surroundings and classifies it, and the areas classified in this way are used as a basis for determining the sub-area. Walls, objects, doors, floor coverings can also be used to determine the boundaries of the subarea. The classifier can contain, for example, a neural network that can carry out a classification of the detected sub-areas, namely the classification determines an area class for each of the detected sub-areas. The detected sub-areas, including the determined area classes, can be saved in the map of the AMR.

If the classifier contains a neural network, this is trained in advance with training data. However, objects can also be classified according to specific, deterministic criteria. For example, a “kitchen” sub-area can be detected by detecting the presence of an oven and/or a coil (for example using image processing/object recognition based on camera images).

An electronic map of the operational area with stored and classified objects enables the user of the AMR to use the map of the operational area, such as visualized on an HMI, more easily/intuitively. Furthermore, the classification of the sub-areas enables the AMR to execute simple commands that are intuitive for the user, such as “clean the kitchen” (abstractly speaking: “clean area of class X”).

The classification of objects using an “intelligent” classifier enables the AMR to assign a descriptive name to a sub-area based on the previously determined area class. When visualizing the map on the HMI, the names of the sub-areas can be displayed and the user does not have to make any manual assignments.

Various classifiers are known per se. Usually, classifiers contain one or more pre-trained neural networks, which not only deliver an area class as a result of the classification, but also provide a measure of the probability of the correctness of the classification. For example, the result of a classification can be that a sub-area is 80% a kitchen and 30% a bathroom. The probabilities do not have to add up to 100%. The result with the highest probability can be used as the object class. It is also possible to only assign an area class when the probability of two area classes has a certain difference. If the probability values are too low, the AMR can repeat the measurements and, for example, use additional sensors or lighting for the measurement. It is also possible to repeat the measurement if the position has changed. It is also possible to manipulate objects in the area or to process the area before a new measurement is taken. The area classifications in adjacent surroundings could also be comprised in the current area detection.

If a classification does not meet the necessary requirements to make an assignment, it is also possible that the classification can be carried out by another classifier. This could, for example, be a classifier that can be reached via a network connection and has a more extensive training data base. It would also be conceivable for this task to be handed over to humans. Due to this expanded possibility of classification, sub-area detection is fully automatic in many cases.

If a classification is incorrect or the user wants to change it for other reasons, such as because the area is used differently than based on the classification, this can be adapted accordingly via a human-machine interface (HMI). In this case, the user could select from a set of possible standard area classes, or create individualized area classes that the system does not yet provide.

In the course of this individualization, sub-area classes for which the classification is less clear than desired could also be suggested to the user for checking. In this way, the system can be highly customized on the one hand and provide low-maintenance on the other due to a high level of automation.

Classifiers usually get better and better with an increasing database. In addition, classifiers can be extended by additional classes. For this reason, it makes sense to set up the system in such a way that the classifiers can be exchanged using an update process. As a result, the robot can recognize additional object classes over time and, based on this, it can be expanded by adding additional functions.

In order to be able to generate classifiers with the appropriate reliability, it is important that a sufficiently large amount of training data is available. One way to get suitable training data is, for example, to use data that the robot has sent to a higher-level classifier for evaluation. In order to enable training with this data, this data must first be assigned to one or more classes. This assignment could be done by humans, for example, or by using that area class that the user ultimately confirms or specifies. Of course, data could also be used in areas that have already been correctly assigned, provided the user makes this data available.

An example also comprises the possibility of providing sub-areas with information that provides an indication about which actions are permitted or not in the corresponding area. This assignment could be done automatically by the robot in a first run based on the object class and later changed by the user. Possibilities for such actions are, for example, the creation of restricted areas for specific service tasks. For example, the detection of a carpet could result in a restricted area (SG) being set up for wet cleaning. Another example would be that a data protection area (DG) is set up for a bathroom in which the robot is prohibited from sending data via a communication interface as shown in FIG. 15. The data protection area and restricted or restricted areas can be implemented both automatically and user-defined. It is also possible to provide sub-areas with the “Edit” action. For example, the detection of a tiled floor could lead to this sub-area being treated with wet cleaning. On the one hand, the benefit here lies in the high level of customizability. Despite this adaptability, the necessary interaction with the user can be reduced to a necessary level due to automation options.

Another example comprises the possibility of providing areas with restricted areas or directional restricted areas depending on their area class. Areas in which toys or similar objects are set up could thus be excluded from processing. A carpet with fringes on two sides, for example, could also be configured in such a way that the robot can leave the carpet from the fringed side, but not drive onto it from this same side. A snagging of a brush of the robot could probably be prevented in this way.

A further possibility of sub-area detection results from the fact that areas in which objects are located are also made available as such in the HMI. The map of the operational area could be shown in more detail in this way as shown in FIG. 16.

Currently, objects in robot maps are often represented as walls. For the user, the resulting map is distorted by the objects. A more intuitive display would be possible if the room is displayed in full size and the objects are displayed as sub-areas of the room which, for example, cannot be driven on. Such a correction is possible through object and/or sub-area recognition. FIG. 16 shows possible variants with which this problem can be solved. A kitchen block (KB) limits the correct measurement of the room. It would be possible, as in (KB1), to use information about walls from the previous map and to calculate the actual room size by extrapolating walls. Another way of estimating the object size is by using the typical sizes of these objects, as shown in KB2. For example, a kitchen unit often can have similar depths. The real position of a wall can also be determined by additional measurements, for example as shown in (KB3).

An example also comprises the possibility of providing sub-areas with information that provides an indication about which parameters are permitted for an action in the corresponding area. This assignment could be done automatically by the robot in a first run based on the object class and later changed by the user. Possibilities for such actions are, for example, changing the processing speed or the acoustic volume in a certain area. Allowing contact between the robot and objects such as a curtain could also be configured in this way. On the one hand, the benefit here lies in the high level of customizability. Despite this adaptability, the necessary interaction with the user can be reduced to a necessary level due to automation options.

The method comprises, in particular, navigating the AMR 100 through an operational area using one or more navigation sensors coupled to the navigation module 152. Information about the surroundings of the AMR in the operational area is detected with the aid of the navigation sensor and/or with additional sensors. Positions in the operational area can be assigned to this information in order to create an electronic map of the operational area or to supplement an existing map. The method further comprises automatically detecting sub-areas within the operational area. On the one hand, the detection can take place by dividing the operational area into sub-areas, such as rooms, in advance, and then classifying these sub-areas. Another possibility is that the robot detects one or more objects and then creates an area in which the objects are located. Another possibility is for the robot to detect and store information about its surroundings. When the robot's state changes, the current position of the robot and its state change are saved. By analyzing this history, it is possible to extract areas where typical state changes occur. For determining the boundaries of the sub-area, walls, objects, doors and floor covering can additionally be used. The detected sub-areas, including the determined area classes, can be saved in the map of the AMR. A combination of the sub-area detection described is also possible. This can result in sub-areas that correspond to rooms, for example. However, sub-areas of rooms can also form, such as carpeted areas, areas in which cables are located. Areas in which toys or dirt lie are created.

For the areas, a measure can be determined from the history, which indicates the probability of completing a service task in a specific area. For example, error messages or a temporary stuck in an area could reduce the probability of a service task. It could also be measured how long the robot remains in an area to complete a service task.

The objects that are in the room, or their number, can positively or negatively affect the measure. For example, a seating group could take more time due to the complex path planning, or cables lying around could lead to the robot getting stuck or, in the worst case, damaged.

Another way to determine the task completion time or task completion probability is to estimate this by using a classifier. For example, an external unit could be assigned the task of assigning a corresponding task completion duration or task completion probability to the sub-area.

By comparing the measure, the sequence of processing several sub-areas can then be ranked. Sub-areas that have corresponding measures could also result in the area not being processed at all. For the customer, this is particularly useful if it is to be ensured that the robot performs its tasks as quickly as possible and that there are no interruptions. In this way

The method comprises, in particular, navigating the AMR 100 through an operational area using one or more navigation sensors coupled to the navigation module 152. The method further comprises detecting at least part of the robot operational area by means of an optical sensor. The area is then classified using a classifier based on the detected information.

The classifier can contain, for example, a neural network that can carry out a classification of the detected areas, namely the classification determines a value for each area that indicates a state of the area. The condition for which the area is checked can take on a wide variety of properties. This state could take on various properties that represent the surface. For example, the evenness of a surface or the cleanliness could be examined as shown in FIG. 12.

However, the property of the degree of contamination could also be determined. If, for example, a neural network is trained with a sufficient number of images for which the degree of soiling is known, a classifier can also calculate a classification with regard to the degree of soiling for other images that have little to do with the previous images.

The property can of course also be calculated by a classifier which is connected to the robot via a communication connection. A neural network could also be used which was trained with a very large amount of data. Due to the higher amount of underlying data, better and more reliable values usually result when determining the respective property.

Of course, the calculation of the property is of particular interest if it can be used to determine whether the surface should be processed. For example, processing could be aborted if no significant change in the measure is to be expected. Processing could also be aborted if damage could result from processing. A further possibility arises from repeated determination and the calculation being carried out before and after a service task in the area. This makes it possible to generate measures that show whether the service task has caused a change. This could also be used to check whether an undesired deterioration in the classified property has occurred.

One possibility that arises from multiple determination of the measure is that, based on the results, a decision can be made as to whether the service task should be carried out again. This could be the case, for example, if the measure has changed to a sufficient extent and another run causes another desired change that is also classified as large enough. Of course, other specifications can also be taken into account in such a decision. For example, the time required for the task could play a role, or whether there are other orders or times when certain tasks must be completed.

Although uploading information and evaluating the information makes sense in many cases, it may be that users do not want this. Examples of this can be, for example, that users do not want to upload information about certain objects, for example people, faces or furnishings such as pictures or the like. In order to solve this problem to a satisfactory degree for the user, it makes sense to set up data protection objects (DO) as shown in FIG. 15. Here the user can enter certain object classes that are made unrecognizable before information is uploaded. The rest of the information can then be uploaded and processed further. A pre-processing of the information takes place for the removal of the information. For example, an image could be detected by the robot on which a person is located. The image is then checked for the presence of objects. If an object is recognizable in the image that falls into a data protection object class, the image is not transmitted. It would also be conceivable that only the region in which the data protection object is located is not transmitted. The removal of the marked areas from the area could be done, for example, by providing the pixels with a uniform value. In order to also remove information from contours, rectangles could be “grayed out”, for example. On the one hand, these data protection objects could be set up by the user himself by specifying data protection objects, or on the other hand semi-automatically by the robot, in that it already suggests a proposal for the creation of data protection objects. It would also be conceivable that all objects are created as data protection areas and the user then releases certain object classes for which it is possible to upload information. It is also conceivable that certain data protection objects may only be processed by certain entities. It could be the case that in an office building it is possible to upload information to a company server, but the information may not be forwarded to the robot manufacturer's server.

Although uploading information and evaluating the information makes sense in many cases, it may be that users do not want this. Examples of this can be, for example, that users do not want to upload any information from the operational area or private areas such as the bathroom. In order to solve this problem to a satisfactory degree for the user, it makes sense to set up data protection areas as shown in FIG. 15. Here the user can mark areas from which no information is forwarded to one or specific units connected via a network. The creation of such data protection areas may be performed by the user itself, by entering data protection areas in the provided map or semi-automatically by the robot, in that the robot already makes a proposal regarding the introduction of data protection areas. It would also be conceivable that all areas are searched for as data protection areas by default and the user then releases certain areas in which it is possible to upload information. It is also conceivable that certain data protection areas can only be processed by certain entities. It could be the case that in an office building it is possible to upload information to a company server, but the information may not be forwarded to the robot manufacturer's server.

The method comprises, in particular, navigating the AMR 100 through an operational area using one or more navigation sensors coupled to the navigation module 152. Using a chemical sensor or a sensor that analyzes light that is outside the visible range, information about the surroundings of the AMR in the operational area is collected. The sensor is intended to detect chemical substances. One or more chemical substances can be detected.

The sensor information can be used to identify objects or their attributes. For example, liquids on the floor could be checked to see if they are water. A distinction between liquids is also possible. For example, water could be distinguished from urine. Walls could also be examined to determine whether and how damp they are. Plants could be examined for their watering status. The use of fluorescence is also conceivable in this examination.

In this case, spectroscopic investigations are a particularly suitable method. In this way, conclusions can be drawn about the composition of the object based on the wavelengths emitted by the object. Since many analysis options for electromagnetic wavelengths lie outside the visible range, there are options that are not immediately obvious at first glance. For example, plastics could be recognized, organic waste classified and so on. Special application possibilities result from the use of hyperspectral imaging cameras. They enable the detecting of images and a simultaneous spectral analysis of the image. This means that even individual areas of objects can be checked for their composition. The use of terahertz technology is also worth mentioning in this context. Although the technology is currently still very expensive, it offers the possibility of penetrating certain materials well. This would make it possible to scan the robot's surroundings better and to see behind walls in some cases. Of course, a sensor that detects chemical molecules in the air can also be used. This could be used to examine objects that spread odors. A possible operational area would be the detection of animal excrement. Air quality could also be checked in this way. If, for example, there is too little oxygen in the air, the AMR could initiate appropriate countermeasures or provide notifications.

The use of these sensors (spectroscopic sensors, odor sensors, etc.) is particularly suitable for determining object classes or object attributes. Of course, information from other sensors can also be comprised in an evaluation.

The method comprises, in particular, navigating the AMR 100 through an operational area using one or more navigation sensors coupled to the navigation module 152. Information about the surroundings of the AMR in the operational area is detected with the aid of the navigation sensor and/or with additional sensors. Positions in the operational area can be assigned to this information in order to create an electronic map of the operational area or to supplement an existing map. The method further comprises the automatic detection of objects within the operational area and classification of the detected objects by means of a classifier based on the detected information. This creates at least one object class.

Situation detection is carried out based on at least this detected object class. With this, the current status of the data detected by the robot is analyzed using a classifier and a situation class is determined. In the simplest case, for example, the current states of the robot could be compared with one or more fixedly defined situation states. If it is determined based on the situation class that the robot is currently in a certain situation, an action is started that depends on this situation class. In this way, the robot can respond to a situation and generate behavior that is particularly adapted to the situation. It is also possible to provide the robot with additional functions that go beyond a standard task.

In addition to object classification, object attributes can also be determined. For example, this could be the color or other properties of the object. For a cleaning robot, for example, it could be important whether a curtain touches the floor or not, or whether a carpet has a certain design, such as fringes.

As already described, the previously determined object class can play a decisive role in classifying the situation. Often, however, the condition of an object is decisive for the situation. In order to take this into account, the attributes of the objects can also be considered when classifying the situation. For example, shoes with laces hanging on the floor could be bypassed by setting up a restricted area, or the side brush of a robot could be switched off in this case. For example, if there are no shoelaces hanging on the floor, there is little risk of a cleaning robot snagging them. In this case, it could also be decided that even shifting shoes while performing the task is permissible.

It is also useful to recognize certain situations that occur when objects of the same class appear more than once. For example, the user's instruction “clean the carpet” could mean that the robot cannot clearly determine which carpet it should clean. In this case, there are several ways to deal with it. For example, all carpets could be cleaned, only the carpet that is in the vicinity of the user, or a corresponding query to the user could be triggered.

The criteria with which the situation classification can be carried out can be stored in a database. This could be directly on the robot, which allows it to act very autonomously. However, the database could also be external, enabling it to provide a vast range of situations and the appropriate response. Of course, it is of particular advantage if the situation database can be changed or expanded. This would allow the robot to learn additional situations and provide new functionalities.

Above all, more complex situations can only be recognized if a more detailed analysis is carried out. It can happen that the presence of an object is an indication of a situation, but the specific reaction to it requires a more detailed analysis. For a more detailed analysis, further information can be comprised as criteria. This could be done both by direct measurement and by querying databases. For example, a detected houseplant could lead to a color determination being carried out, which is then used to decide whether watering makes sense. It would also be conceivable that further information that is available externally is comprised. For example, an online weather service could comprise the expected humidity and thus better assess a situation.

Since situation detection can be very complex depending on the implementation, it makes sense to only do this in certain situations. It has proven to be particularly useful that a situation check is only carried out when a new object is detected, it is detected again or it is no longer detected although it should be present.

Triggering by an external event could also be useful in numerous applications. For example, a cloud service could send a signal that a user is on his way home or that the weather is about to change. Based on such external triggers, the robot can recognize corresponding situations and initiate appropriate reactions. In the event of a storm warning, for example, it could close the windows or doors. After entering the apartment, the entrance area could also be cleaned, for example optionally wet if the weather report indicates that it has rained or damp dirt is detected in the entrance area.

Internal cyclic triggers can also be used to allow situation detection to be carried out in the meantime. In this way, on the one hand, situations can be checked and, on the other hand, it can be ensured that the actual main tasks of the robot can continue to be carried out.

Another particularly useful time to perform a situation check is when it occurs upon one or specific internal state changes of the robot. For example, error messages or warnings could indicate that the robot is not in a standard situation. Triggering a situation assessment is of course particularly useful in this case, since a suitable reaction can be carried out based on this.

Of particular importance for a situation is of course the current state of a robot. The service task that is currently being carried out is particularly important. This can be used as a criterion for determining the situation. In addition, of course, information from the history of the robot or external information made available by a communication unit can also be used as a criterion.

Various classifiers are known per se. Usually, classifiers contain one or more pre-trained neural networks, which not only deliver an area class as a result of the classification, but also provide a measure of the probability of the correctness of the classification. For example, the result of a classification can be that 80% of a situation is caused by contamination of a operational area and 30% by faulty sensors on the robot. The probabilities do not have to add up to 100%. Depending on the probability determined, a classified partial area or a classified object can be stored or not stored in the robot's map, such as if the probability is sufficiently high. The result with the highest probability can be used as the object class. It is also possible to only assign an area class when the probability of two area classes has a certain difference. If the probability values are too low, the AMR can repeat the measurements and, for example, use additional sensors or lighting for the measurement. It is also possible to repeat the measurement if the position has changed. It is also possible to manipulate objects in the area or to process the area before a new measurement is taken. The area classifications in the surrounding area could also be comprised in the current area detection. Furthermore, it is conceivable for the robot to have the situation classified or checked by a higher-level entity. This could be made available via a cloud service, for example. Above all, the situation classification can be significantly improved in this way, since situations can represent very complex circumstances that can only be correctly classified by a correspondingly complex classifier. It would also be possible to have people classify situations in this way.

A number of actions can be initiated based on a recognized situation. Above all, the following actions are considered to be particularly suitable, which result in a direct reaction to the situation. The current service task could be changed or stopped entirely. The current service task or tasks can also be postponed or paused to resolve the situation. A higher entity, another service robot or the user could also be requested to create a situation that enables subsequent work to continue.

When commanding a higher entity or the user, a sequence of work orders could be generated that represents a solution to a specific situation. The robot could then carry out these work orders. For example, a puddle of water on the floor that occurs during a dry clean, such as vacuum could cause the job to pause and create an area around the puddle that is intended for a wipe clean. The robot switches to wipe cleaning and works on the area, after a subsequent drying phase in which other service jobs can be carried out, and the suction process in this area is started again.

Another possibility offered by situation recognition is that parameters are adjusted during the service task in such a way that the service function can be carried out better. In the case of heavy soiling, for example, the suction power of a vacuum robot could be increased. If the robot carries out the cleaning in the presence of people or animals, or if it takes place at a certain time, such as at night, it could be switched to a “quiet mode”. Similar possibilities arise with other parameters, for example speeds, distances, threshold value detections and the like.

The method comprises, in particular, an AMR. Internal statuses, such as error messages, changes in the status machine are detected and recorded. This information can then be queried via an external unit, for example a cloud service, and examined to determine whether a specific internal state is present. If this is the case, information will be sent to the user. This can be made available, for example, via an HMI on the robot or via an HMI with which the user can control the AMR. In this way, the user can be provided with information that is highly relevant to his application. Thus, he does not get an overload of information and will react more comfortably to relevant information as shown in FIG. 14.

This method is of particular advantage if the AMR can also trigger this action itself. For example, it would be possible for an AMR to repeatedly receive the same internal warning. (such as: the job was canceled at position X, Y due to a warning Z. In this way, a robot could prompt targeted information and offer suggested solutions.

Some warnings can be accepted as usual for the application. The warning “pause cleaning to charge the battery, recharge” is common in large apartments. However, in the case of a small apartment, this should not happen often. In this case, it makes sense that information that can be extracted from the map is also examined.

The status of robot components can also be relevant. The number of square meters cleaned, the running time of motors, fans, filters, etc. could indicate certain signs of wear and suitable information for the user can be useful.

This function is particularly relevant for the timely provision of spare parts. For example, the warning “Pause cleaning to charge the battery. Recharge” could indicate that the battery is aging. Information about this could be displayed to the user. The same applies to spare parts such as brushes and filters of cleaning robots. Additional information could also be considered. For example, a message could only be sent to the user when spare parts that will soon be required can be purchased cheaply.

It could also be used to advertise products that are particularly relevant due to the operational area. A wiping extension could be recommended if floors requiring this are available in the apartment. Software that is suitable for the apartment could also be suggested or downloaded. For example, a WiFi repeater function could be suggested if WiFi is only available in part of the apartment. The robot could then drive into a border area of the apartment where it still has a connection to the Internet and increase this access with a repeater function.

In this case, of course, the possible applications go far beyond spare parts or robot software. Information about furnishings or products from third-party suppliers, for example, could also be made available. Above all, the map data and the objects already in the living room could be evaluated and useful extensions suggested.

Similar possibilities arise if it is determined that users do not use certain functions of the AMR at all, although these would be well suited for their purposes. In this case, an indication of unused or newly added functions could be made possible.

Of course, the use of a Human Machine Interface (HMI) with voice control is also possible for the applications mentioned above. For example, the robot could speak directly to the user or the output or input could also take place via smartphone or a smart home solution.

The use of text-based messenger services such as Whatsapp, Telegram, SMS, e-mail or similar would also be possible and has various advantages for the user depending on the application. Due to the possibility of using different communication systems, the user can often fall back on his usual or preferred communication medium in order to also exchange information with the robot.

Of course, an HMI that is attached directly to the robot offers the user the advantage that information can be exchanged directly with the robot-in this case the user does not need any other devices to operate the robot or to get information from the robot.

An HMI via the robot can operate via buttons, lighting, screen as well as voice input and/or voice output. In addition, the HMI can be adapted in such a way that a certain degree of configurability is possible for the user. For example, the user could set special colors for the HMI or select different dialects and languages. This offers the advantage that better communication with the user is possible and the robot can be better adapted to the surroundings. This offers great advantages, especially in cases where the robot is subject to certain restrictions due to the operational area. For example, a bedroom or lab might need a setting where the robot emits as little light or noise as possible. Customization could also provide certain themes that make a pre-selection of settings. Examples are “dark mode”, “quiet mode”, “happiness mode” etc. There is also the possibility to provide the robot with character traits. This can also be done visually, but is primarily possible for vocal and textual HMI. The robot could use it to communicate the same information in different ways, depending on the setting. For example, it could give the impression that it is happy, or annoyed by certain errors or tasks, excited when it is allowed to try something new, add funny points to information, tell anecdotes, etc. This offers the advantage that the user builds a stronger emotional bond with the robot and is therefore likely to take better care of and maintain it. In this way, the robot can in turn be better adapted to the operational area and the user benefits from better completion of the work carried out by the AMR.

Since not every user or manufacturer is interested in such a system, it makes sense to enable or disable such functions. Both the user and the manufacturer could deactivate these functions partially or completely. It would also be conceivable that only the user or only the manufacturer would have these options. It is also possible to modify such functions or to reload them. For example, a special dialect could be reloaded or messages from certain categories could be suppressed. Activating or deactivating such functions also offers the possibility of monetization.

In order to determine the relevance of a message for a user, a decision must be made based on the information available on whether it should be provided or not. A targeted option is to determine a value that expresses how relevant a message is. There are again numerous possibilities for determining the value. For example, a relevance classifier could be developed using a neural network. However, certain states could also be checked and used to determine a certain value. Another possibility is that a human analyzes the data and thus determines a measure of relevance.

Numerous pieces of information can be used to determine the measure. Of particular interest is the possibility of using cloud services. With them it is possible, for example, to comprise additional special offers, price comparisons, weather data, health information and other information in the relevance calculation. In this way, attention could only be drawn to a new battery when the price is 20% below the previous average value. Or if pollen allergy season is imminent, the possibility of a special pollen filter or a cloth could be pointed out in good time.

Of course, the use of such a measure results in the possibility of sending information only if it lies within a certain range of values. It will often be such that the most relevant functions are made available. Depending on the structure of the measure calculation, this can apply to certain value ranges.

The exemplary embodiments described here are summarized below, which is not an exhaustive but merely an exemplary list of exemplary embodiments:

1. A method for an autonomous mobile robot (AMR) comprising:
navigating the AMR through an operational area using one or more navigation sensors while the AMR is performing a service task;
detecting information about the surroundings of the AMR in the operational area by means of at least one first sensor, for example the navigation sensor;
automatically detecting objects and classifying the detected objects by means of a classifier based on the detected information, wherein an object class is determined;
storing detected objects including the determined object class in an electronic map of the AMR.

Example 2 The method according to example 1,
wherein the classified objects are visualized for the user on a map or provided with a descriptive name and optionally wherein their attributes are made available.

Example 3: The method according to any one of the previous examples,
wherein one or more object attributes and/or a pose of a classified object are determined and stored in addition to the object class of a detected object.

Example 4: The method according to any one of the previous examples, wherein classifying the detected objects comprises:
determining a measure of the probability of the classification being correct; and storing this measure for at least one object class in the map.

Example 5: The method according to any one of the previous examples, wherein classifying the detected objects comprises:
determining a measure of the probability of the classification being correct; and
if the probability is below a limit value, repeating the classification of the detected object with a changed position of the robot and/or with the help of additional sensor data and/or by illumination of the detected object.

Example 6: The method according to any one of the previous examples, wherein classifying the detected objects comprises:
determining a measure of the probability of the classification being correct; and
if the probability is below a limit value, repeating the classification of the detected object after manipulation of the detected object.

Example 7: The method according to any one of the previous examples,
wherein classifying the detected objects comprises:
determining a measure of the probability of the classification being correct; and
if the probability is below a limit value, repeating the classification of the detected object by an external entity connected to the robot via a communication connection, in particular a cloud server.

Example 8: The method according to any one of the previous examples,
wherein the detected objects are made available to the user, who has the option of entering or changing the class.

Example 9: The method according to any one of the previous examples,
wherein the detected objects are made available to the user for which the measure of the probability of correctness falls below a specified value.

Example 10: The method according to any of the previous examples, in which the robot is provided with a map in which classes are associated with at least one permitted action. wherein the permitted actions comprise at least one of the following:
creating a restricted area around the object,
allowing a processing of the object,
taking up maintenance/inspection of the object,
allowing moving of the object.

Example 11: The method according to any of the previous examples, wherein the specific action comprises:
manipulating an object by the robot, wherein it is previously checked whether this is allowed based on the assignment of the class and the allowed action.
(as long as the measure of probability of correctness of the class assigned to the object is determined to be sufficient.

Example 12: The method according to any one of the previous examples,
wherein the classifier can be updated via an update over a network connection

Example 13: The method according to any one of the previous examples, further comprising:
transmitting at least part of the detected information and the classification of an object based thereon to a higher-level entity; and
using the transmitted information as training data for generating and/or optimizing a further classifier.

Example 14: The method according to any one of the previous examples, further comprising:
sending information to the user or a unit connected via a communication unit about the status of an object if it is in a certain class or the attributes indicate this (water damage, houseplant)

Example 15: The method according to any one of the previous examples, further comprising:
sending information about the status of an object if the object is detected for the first time

Example 16: The method according to any of the previous examples, further comprising:
sending information about the status of an object if the attributes of the object are in a certain value range of a measure.

Example 17: The method according to any one of the previous examples, further comprising:
providing energy or information to objects.

Example 18: The method according to any one of the previous examples, further comprising:
providing energy or information for objects, by electrical contacts or with the help of electromagnetic radiation.

Example 19: The method according to any one of the previous examples, further comprising:
providing energy or information for objects using a contact-less charging unit.

Example 20: The method according to any one of the previous examples, further comprising:
providing energy or information for objects if it is detected that the object should be supplied with energy or information. (such as due to loading status, firmware version).

Example 21: The method according to any one of the previous examples, further comprising:
providing energy or information for objects using a robot's energy source.

Example 22: The method according to any one of the previous examples, further comprising:
3D extraction of the object's dimensions and storing the information.

Example 23: The method according to any one of the previous examples, further comprising:
extracting texture of the object and storing the information.

Example 24: The method according to any one of the previous examples, further comprising:
using the data from 3D extraction or texture extraction for visualization in the HMI.

Example 25: A method for an autonomous mobile robot (AMR) comprising:
navigating the AMR through an operational area using one or more navigation sensors while the AMR is performing a service task;
detecting information about the surroundings of the AMR in the operational area by means of at least one first sensor, wherein the at least one first sensor is designed to detect chemical substances or to examine electromagnetic waves that are outside the visible range.

Example 26: The method according to example 25, wherein sensor information relating to one or more detected chemical substances is taken into account in the object classification or the determination of object attributes.

Example 27: The method according to example 25 or 26,
wherein the first sensor is a hyperspectral imaging camera or a spectrometer or an olfactory sensor.

Example 28: The method according to any one of examples 25 to 27,
wherein sensor information relating to one or more detected chemical substances is taken into account in the object classification or the determination of object attributes.

Example 29: A method for an autonomous mobile robot (AMR) comprising:
navigating the AMR through a operational area using one or more navigation sensors while the AMR is performing a service task;
detecting information about the surroundings of the AMR in the operational area by means of at least one first sensor, for example the navigation sensor;
automatically detecting objects and classifying the detected objects by means of a classifier based on the detected information, wherein an object class is determined;
recognizing a situation in which the robot is currently present, based on one or more criteria that comprise at least the presence or absence of an object of a specific object class in the operational area, or recognizing a situation in which the robot is currently present using a classifier based on the detected information, wherein a situation class is determined; and
performing a specific action by the robot depending on the detected situation.

Example 30: The method according to example 29,
wherein one or more object attributes and/or a pose of a classified object are determined and stored in addition to the object class of a detected object.

Example 31: The method according to example 29 or 30,
wherein the criteria further comprise one or more object attributes and/or a pose of the object of a classified object.

Example 32: The method according to any one of examples 29 to 31,
wherein the criteria further comprise the presence of at least one other object of the same or another object class in the operational area

Example 33: The method according to any one of examples 29 to 32, wherein the criteria are stored in a database and the method further comprises updating and/or expanding the criteria stored in the database.

Example 34: The method according to any one of examples 29 to 33, wherein detecting the situation the robot is currently in comprises:
checking a first criterion, namely whether an object of a specific object class is located in the robot operational area;
checking one or more other criteria that depend on the object class or the object attributes.

Example 35: The method according to any one of examples 29 to 34, wherein the recognition of the situation in which the robot is currently in is performed if:
a new object is detected;
an object that previously existed in the operational area is no longer present;
an external trigger event triggers recognition of the situation;
a cyclic trigger triggers recognition of the situation;
an internal trigger event due to a status change of the robot, for example when an error occurs, triggers recognition of the situation.

Example 36: The method according to any one of examples 29 to 35, wherein the criteria further comprise:
an internal status of the robot, in particular a current service order of the robot;
information derived from the history of the robot;
external information that is received in particular via a communication connection, for example an Internet connection.

Example 37: The method according to any one of examples 29 to 36, wherein the specific action comprises:
verifying the situation through additional measurements; and/or
verifying the situation by requesting a higher-level entity, in particular a server connectioned to the AMR by means of a network connection, or a user.

Example 38: The method according to any one of examples 29 to 37, wherein the specific action comprises:
modifying the current service task;
stopping, postponing or pausing the current service task for a fixed or variable period of time;
commissioning another service entity, the user or a higher entity.

Example 39: The method according to any one of examples 29 to 38, wherein the specific action comprises:
sending a request to a higher-level entity or the user, and receiving one or more orders to deal with or change the situation from the higher-level entity or the user; and
carrying out the received work orders.

Example 40: The method according to any one of examples 29 to 39, wherein the performing of a certain action by the robot depending on the recognized situation comprises:
changing the parameters of a service task that is currently being carried out, for example the speed of the robot.

Example 41: A method for an autonomous mobile robot (AMR) comprising:
detecting and collecting information about the internal states (such as error messages) of the AMR;
querying this information or information extracted therefrom, via an external unit, whether a certain internal state is present; and
if yes, sending information to the robot or an HMI by means of which a user is connected to the robot.

Example 42: The method according to example 41,
wherein the method of example 69 is triggered by a condition occurring at the AMR, such as when it is turned on.

Example 43: The method according to example 41 or 42,
the collected information additionally comprises information from the map of the operational area.

Example 44: The method according to any one of examples 41 to 43,
wherein the collected information additionally comprises information about the status of components of the robot. (Replacement of spare parts)

Example 45: The method according to any one of examples 41 to 44,
wherein the information sent contains information about possible spare parts, wearing parts or accessories for the robot.

Example 46: The method according to any one of examples 41 to 45,
wherein the information sent contains information about possible objects for the operational area (advertising).
or wherein the information sent contains information about possible additional functions for the operational area (advertising).

Example 47: The method according to any one of examples 41 to 46,
wherein the information sent provides information about the possibilities of changing the use of the robot.

Example 48: The method according to any one of examples 41 to 47,
wherein the information is sent via a voice HMI.

Example 49: The method according to any one of examples 41 to 48,
wherein the information is sent via a messenger service.

Example 50: The method according to any one of examples 41 to 49,
wherein the information is sent to the robot and is output by it via an HMI on the robot.

Example 51: The method according to any one of examples 41 to 50,
wherein the information is individualized (adapted to the user).

Example 52: The method according to any one of examples 41 to 51,
wherein the method according to example 69 can be switched on or off or switched on by the user or the manufacturer.

Example 53: The method according to any one of examples 41 to 52,
wherein a measure is determined with which the relevance for the user is determined.

Example 54: The method according to any one of examples 41 to 53,
wherein information is also used, that is obtained via a communication connection, in particular a cloud server, to determine the measure (price comparisons)

Example 55: The method according to any one of examples 41 to 54,
wherein information is only sent if this measure assumes a certain range of values.

1. A method, comprising:
navigating an autonomous mobile robot through an operational area using one or more navigation sensors;
detecting information about surroundings of the robot in the operational area;
automatically detecting sub-areas within the operational area;
classifying the detected sub-areas as an area class with a classifier based on the detected information; and
storing detected sub-areas including the determined area class in an electronic map of the robot;
visualizing, via a human-machine interface, the detected sub-areas, wherein a user has an option of entering or changing the area class;
wherein the classifier, when classifying the detected sub-area, takes into account which objects are detected in the sub-area, and/or;
wherein a measure for a classification correctness probability of a sub-area is determined and the sub-area is stored in the map depending on the measure.

2. (canceled)

3. The method according to claim 1, wherein classifying the detected sub-area comprises:
determining that the measure for the classification correctness probability is correct; and
storing the measure for the classification correctness probability for at least one object class in the map.

4. The method according to claim 1, wherein the classifying of the detected sub-areas comprises the following:
determining that the measure for the classification correctness probability is correct; and
if the measure for the classification correctness probability satisfies a predetermined condition, repeating the classifying the detected sub-area in a changed position of the robot, with additional sensor data, illumination of the detected sub-area, or a combination thereof.

5. The method according to claim 1, wherein classifying the detected sub-area comprises:
determining that the measure for the classification correctness probability is correct; and
if the measure for the classification correctness probability satisfies a predetermined condition, repeating the classifying the detected sub-area after manipulation of the detected sub-area by moving an object in the sub-area or performing a service task in the sub-area.

6. The method according to claim 1, wherein classifying the detected sub-area comprises:
determining that the measure for the classification correctness probability is correct; and
if the measure for the classification correctness probability satisfies a predetermined condition, repeating the classifying the detected sub-area by an external device in communication with the robot.

7. (canceled)

8. The method according to claim 1, further comprising visualizing, via a human-machine interface, detected sub-areas for which the measure for the classification correctness probability satisfies a predetermined condition.

9. The method according to claim 1, wherein the classifier is updated via an update over a network connection.

10. The method according to claim 1, further comprising:
transmitting at least part of the detected information and the classification of the sub-area based thereon to a higher-level entity; and
using the transmitted information as training data for generating and/or optimizing a further classifier.

11. The method according to claim 1, further comprising:
selecting, based on an area class, an action from a table in which area classes are assigned to actions,
wherein the actions comprise:
creating a restricted area in the sub-area;
allowing processing of subarea;
creating a data protection area; or
a combination thereof.

12. The method according to claim 1, further comprising:
detecting objects in the operational area;
classifying the detected objects as an object class with a classifier based on the detected information;
inserting a restricted area on a map of the robot, around the detected and classified object, or
inserting restriction lines, which may only be crossed by the robot from one direction, on the robot's map.

13. The method according to claim 1, which further comprises the following:
detecting additional objects in one of the detected sub-areas;
expanding the detected sub-area so that space occupied by the detected object is not visualized for the user as a wall or boundary of the room.

14. The method according to claim 13, further comprising:
detecting a wall; and
expanding the sub-area by an area occupied by the detected object up to the detected wall and updating the map.

15. The method according to claim 13, further comprising:
extrapolating a course of the wall next to the detected object in order to infer the position of the wall behind the object; and
extending the sub-area by the area occupied by the object up to the position of the wall behind the object and updating the map.

16. The method according to claim 13, further comprising: expanding the sub-area by an area that has a typical size for the detected object.

17. The method according to claim 1, further comprising:
performing a service task, which is characterized by one or more parameters, in a sub-area;
changing a parameter of the service task depending on the area class of the sub-area.

18. A method, comprising:
creating a map of an operational area of a robot;
subdividing the operational area into sub-areas;
inputting the sub-areas in the map;
determining a measure for each sub-area and a specific service task of the robot, wherein the measure represents a probability the robot can complete the service task in the respective sub-area or duration with which the robot can complete the service task in the respective sub-area.

19. The method according to claim 18, further comprising:
logging obstacles and errors in the implementation of the service task for determining the measure during operation and for each sub-area, wherein determining the measure for each sub-area is based on the logged obstacles and errors.

20. The method according to claim 19,
logging objects when the service task is carried out for determining the measure during operation and for each sub-area, wherein the objects and object classes used in determining the measure for the respective sub-area.

21. The method according to claim 18, further comprising:
detecting information about robot surroundings for determining the measure during operation and for each sub-area;
processing the information using a device connected via a communication link, wherein the processed information is used in the determination of the measure for the respective sub-area.

22. The method according to claim 18, further comprising:
entering the measure determined for various detected and classified sub-areas is entered in a database or map of the robot and
wherein the implementation of a service task in the sub-areas is prioritized depending on the associated measures, and/or the implementation of the service task in a specific sub-area is prevented when the associated measure meets a predetermined condition.

23. A method, comprising:
navigating an robot through a robot operational area and performing a surface processing task or a surface inspection task in at least a region of the robot operational area
detecting at least part of the robot operational area using an optical sensor;
classifying the data supplied by the optical sensor using a classifier, wherein the classifier calculates a value that represents a property of the surface.

24. The method according to claim 23; wherein the classifier comprises a neural network, and the value calculated by the classifier represents the cleanliness of the surface.

25. The method according to claim 23; wherein the neural network is pre-trained with training data and the neural network is provided to the robot via a communication connection.

26. The method according to claim 23; wherein the robot carries out the classification before and after a service task and determines a measure based on the values calculated by the classifier.

27. The method according to claim 26; wherein the robot performs the service task again when the measure meets a predetermined criterion.

28. (canceled)

29. (canceled)

30. (canceled)

31. (canceled)

32. (canceled)

33. (canceled)
